(19) United States
(12) Patent Application Publication
(10) Pub. No.: US 2026/0100627 A1
(43) Pub. Date: Apr. 9, 2026

(54) ARRAY DEVICE FOR HAIRPIN TYPE STATOR COIL

(71) Applicants: Hyundai Motor Company, Seoul (KR); Kia Corporation, Seoul (KR); Hyundai Wia Corporation, Changwon (KR); Hyundai Mobis Co., Ltd., Seoul (KR)

(72) Inventors: Heedong Son, Hwaseong (KR); Sungdae Hyun, Hwaseong (KR); Changmin Park, Hwaseong (KR); Sang Uk Jeon, Hwaseong (KR); Heewoong Kim, Hwaseong (KR); Hyun Wook Nam, Suwon (KR); Cheol Bae Park, Changwon (KR)

(21) Appl. No.: 19/264,524

(22) Filed: Jul. 9, 2025

(30) Foreign Application Priority Data
Oct. 7, 2024 (KR) 10-2024-0135449

(51) Int. Cl. H02K 15/0643; H02K 15/02

(52) U.S. Cl. CPC H02K 15/0643; H02K 15/02; H02K 2215/00

(57) ABSTRACT

Provided is an array device for a hairpin type stator coil. The array device, configured to array hairpin type stator coils on at least one array jig transported through a conveyor, may include i) a frame, ii) at least one magazine that is arranged in a magazine stack part installed in the frame and has the stator coils loaded along a set loading direction, iii) a magazine loading unit that is installed in the frame to load the at least one magazine into a magazine tilting part arranged in front of the magazine stack part, iv) at least one buffer unit that is arranged in front of the magazine tilting part, v) at least one cartridge unit that is arranged in front of the at least one buffer unit, and vi) a coil insertion unit that is arranged in front of the at least one cartridge unit to insert the stator coils.

### CROSS-REFERENCE TO RELATED APPLICATION

This application claims under 35 U.S.C. § 119(a) the benefit of Korean Patent Application No. 10-2024-0135449 filed with the Korean Intellectual Property Office on Oct. 7, 2024, the entire contents of which are incorporated herein by reference.

### BACKGROUND

### Technical Field

The present disclosure relates to a stator manufacturing system of a hairpin winding type, and more particularly, to an array device for a hairpin type stator coil that is configured to array hairpin type stator coils inserted into a stator core.

### Background

In general, hybrid vehicles or electric vehicles, which are called eco-friendly vehicles, apply a technology that generates driving force by a driving motor.

As a part of efforts to reduce the weight and volume of vehicles and parts, automakers and eco-friendly part manufacturers are developing driving motors having stators with hairpin type stator coils wound thereon.

Such hairpin winding type stators are manufactured through a process of winding hairpin type stator coils on a stator core, a process of welding the stator coils wound on the stator core, etc.

The process of winding the hairpin type stator coils is applied by gripping each stator coil by a multi-axis robot and inserting the stator coils into a separate dummy core jig and inserting the arrayed stator coils in the dummy core jig into the slots of the stator core.

However, when arraying the stator coils (e.g., U-shaped stator coils) on the dummy core jig, a disarray of the stator coils with respect to the dummy core jig may occur due to a dispersion of leg portions of the stator coils and the gripping instability of the multi-axis robot.

Furthermore, since the multi-axis robot grips each stator coil and inserts the stator coils into the dummy core jig, the overall array cycle time of the stator coils may increase.

The above information disclosed in this Background Art is only for enhancement of understanding of the background of the disclosure and therefore it may contain information that does not form the prior art that is already known in this country to a person of ordinary skill in the art.

### SUMMARY

The present disclosure provides an array device for a hairpin type stator coil capable of absorbing a dispersion of shapes of stator coils and arraying the stator coils on array jigs at high speed.

According to some example embodiments, an array device for a hairpin type stator coil, which is configured to array hairpin type stator coils on at least one array jig transported through a conveyor, includes: i) a frame; ii) at least one magazine that is arranged in a magazine stack part installed in the frame and has the stator coils loaded along a set loading direction; iii) a magazine loading unit that is installed in the frame to load the at least one magazine into a magazine tilting part arranged in front of the magazine stack part; iv) at least one buffer unit that is arranged in front of the magazine tilting part to extract the stator coils one by one from the at least one magazine arranged in the magazine tilting part and load and extract a set quantity of the stator coils; v) at least one cartridge unit that is arranged in front of the at least one buffer unit to load the stator coils extracted from the at least one buffer unit, extract the stator coils one by one, and maintain a leg portion of the extracted one stator coil in a set posture; and vi) a coil insertion unit that is arranged in front of the at least one cartridge unit to insert the stator coils extracted one by one from the at least one cartridge unit into the array jig.

The array device may further include at least one magazine door opening/closing part that is installed on a post mounted on the frame to open/close a door block mounted on an upper portion of the at least one magazine.

The at least one magazine door opening/closing part may include: a moving block that is connected to a main opening/closing cylinder installed on the post and moves forward and backward in an up-down direction by an operation of the main opening/closing cylinder; a sub-opening/closing cylinder that is installed on the moving block and has a magnet member mounted on an end portion of an operating rod that is movable forward and backward in the up-down direction; and a spacer pad made of a rubber material that is fixed to a cylinder body of the sub-opening/closing cylinder so that the operating rod penetrates therethrough.

The magnet member may be coupled to a magnet attach block fixed to the door block.

The at least one buffer unit may include: a buffer body that is fixed to the frame; a magazine coil extraction part that is connected to a first buffer cylinder installed in the buffer body and arranged along an inclination direction of the at least one magazine tilted by the magazine tilting part; a pair of buffer fixed guiders that is fixed to an upper portion of the buffer body with the magazine coil extraction part interposed therebetween and arranged along the inclination direction; and a buffer movable guider that is arranged between the buffer fixed guiders, connected to a second buffer cylinder installed in the buffer body, and arranged along the inclination direction.

The at least one buffer unit may further include: at least one coil detection sensor that is installed in the buffer body to detect the quantity of the stator coils loaded on the buffer fixed guiders;

The at least one buffer unit may further include: an upper stopper that is mounted on the upper portion of the buffer body to support a head portion of the stator coils loaded on the buffer fixed guiders; and a lower stopper that is installed on a lower portion of the buffer body to be movable in the up-down direction to support leg portions of the stator coils.

The buffer movable guider may move to a position higher than the upper stopper by the second buffer cylinder.

The buffer movable guide may be coupled to a buffer movable block connected to the second buffer cylinder.

A connection block may be coupled to the buffer movable block along the up-down direction.

The lower stopper and the connection block may be link-coupled to a seesaw type link member installed on the buffer body.

The at least one cartridge unit may include: a cartridge body that is connected to a cartridge driver installed on the frame and mounted on a movable member installed on the frame so as to be movable in the front-back and left-right directions; a pair of first cartridge fixing guiders that is fixed obliquely in a front-back direction on the upper portion of the cartridge body; a pair of second cartridge fixing guiders that are connected to front portions of the first cartridge fixing guiders and are fixed obliquely to the cartridge body along an inclination direction of the first cartridge fixing guiders; and a pair of cartridge movable guiders that are connected to a cartridge cylinder installed in the cartridge body and are arranged obliquely along the inclination direction.

The second cartridge fixing guiders may be arranged higher than the first cartridge fixing guiders.

Each of the second cartridge fixing guiders may be provided with a coil mounting protrusion.

The cartridge movable guiders may be fixed to a cartridge movable block connected to the cartridge cylinder.

A head stopper supporting a head portion of the one stator coil may be mounted on the cartridge movable block.

The at least one cartridge unit may further include: a pair of coil clampers that is rotatably installed in the cartridge body.

The at least one cartridge unit may further include: a pair of upper leg guide modules that is installed in the cartridge body in front of the coil clampers; and a pair of lower leg guide modules that is arranged between the upper leg guide modules and movably mounted in the cartridge body in the front-back direction.

Each of the coil clampers may include a clamp block that is connected to a clamp driver installed in the cartridge body and has coil clamp grooves formed at positions corresponding to the upper leg guide modules.

Each of the upper leg guide modules may include: a fixed guide block that is fixed to the cartridge body along the up-down direction and provided with a rail groove supporting the leg portion of the one stator coil; and a rotation guide block that is rotatably mounted on the fixed guide block so as to be joined with the rail groove and form a rail guide pocket and connected to the fixed guide block through a spring.

Each of the lower leg guide modules may include: a cam roller that is rotatably installed on a cam block movably mounted in the front-back direction through a spring on the cartridge body and selectively coupled to a cam follower groove formed on the cartridge body; and a leg guide block that is connected to a front portion of the cam block through the spring so as to come into contact with the leg portion of the one stator coil and is rotatably mounted on the cam block.

The at least one cartridge unit may further include: a tilting stopper that is rotatably mounted on the cartridge body to support the stator coils loaded on the first cartridge fixing guiders.

A support block may be mounted on the cartridge body, and a slide bar may be mounted on the support block so as to be movable in the front-back direction through the spring.

The tilting stopper may be rotatably coupled to the support block and is jointly coupled to a front-end portion of the slide bar.

The coil insertion unit may include; a coil insertion driver that is installed on a mounting bracket fixed to the frame; a push block that is connected to the coil insertion driver and movably provided in the up-down direction by the operation of the coil insertion driver; and a cam pusher that is coupled to the push block.

The array device may further include: a jig docking part that is docked and coupled to the at least one array jig and installed at a docking point set on the conveyor so as to rotate the at least one array jig.

The at least one array jig may include: a rotating member that is docked and coupled to the jig docking part and rotatably mounted on a jig base; at least one fixed ring that is coupled to the rotating member; and a plurality of jig pins that are radially arranged on at least one fixed ring.

The at least one array jig may include at least one jig spring that is radially arranged on a set outer circumference of the at least one fixed ring.

The at least one array jig may further include: a support ring that is fixed to the jig base with the at least one fixed ring arranged on the inside; and a plurality of coil pockets that are radially movably mounted on the support ring and move radially outwardly of the support ring by a pocket moving unit installed on the conveyor.

According to the array device for a hairpin type stator coil according to example embodiments of the present disclosure, since the dispersion of the shape of the stator coils may be absorbed and the stator coils may be arrayed on the array jigs, it is possible to secure the array quality of the stator coils.

In some embodiment, an array device includes a frame; at least one magazine arranged to hold a plurality of hairpin-type stator coils; a buffer unit positioned to receive and extract the stator coils from the at least one magazine, each extracted coil being maintained in a set posture; at least one cartridge unit arranged to receive the extracted coils from the buffer unit; and a coil insertion unit configured to insert the stator coils from the cartridge unit into at least one array jig. The magazine, buffer unit, cartridge unit, and coil insertion unit are arranged along a process path so that the hairpin-type stator coils are automatically transferred, oriented, and inserted into the at least one array jig.

The buffer unit may further comprise a buffer body fixed to the frame; at least one buffer cylinder coupled to a magazine coil extraction part that is arranged along an inclined direction to withdraw coils from the tilted amgaine; a pair of buffer fixed guiders disposed along the inclined direction; a buffer movable guider disposed between the buffer fixed guiders and operably connected to a second buffer cylinder for movement along the inclined direction; a lower stopper arranged at a lower portion of the buffer body and movable in an up-down direction so as to support a leg portion of each extracted coil; and a seesaw-type link member coupling the lower stopper to a connection block that travels with the buffer movable guider, so that upward or downward motion of the buffer movable guider is linked to motion of the lower stopper.

The at least one cartridge unit may comprise a cartridge body mounted on a movable member so as to be displaceable in a front-back and left-right direction; a pair of first cartridge fixing guiders that is disposed obliquely in a front-back direction on an upper portion of the cartridge body; a pair of first cartridge fixing guiders that is disposed obliquely in a front-back direction on an upper portion of the cartridge body; a pair of second cartridge fixing guiders connected respectively to front portions of the first cartridge fixing guiders and arranged obliquely along an inclination direction of the first cartridge fixing guiders; and at least one coil clamper configured to temporarily clamp each stator coil received from the buffer unit and hold the coil in alignment for insertion into the array jig.

The coil insertion unit may comprise a coil insertion driver mounted on a bracket fixed to the frame; a push block connected to the coil insertion driver and movable up and down by operation of the coil insertion driver; and a cam pusher coupled to the push block and arranged to push each stator coil into the at least one array jig.

Other effects that may be obtained or are predicted by an example embodiment will be explicitly or implicitly described in a detailed description of an example embodiment. That is, various effects that are predicted according to an example embodiment will be described in the following detailed description.

### BRIEF DESCRIPTION OF THE DRAWINGS

Since the accompanying drawings are provided only to describe example embodiments of the present disclosure, it is not to be interpreted that the spirit of the present disclosure is limited to the accompanying drawings.

FIG. 1 is a schematic diagram illustrating an example of a hairpin winding type stator according to some example embodiments of the present disclosure.

FIG. 2 is a perspective view illustrating an array device for a hairpin type stator coil according to some example embodiments of the present disclosure.

FIG. 3 is a side view illustrating the array device for a hairpin type stator coil according to some example embodiments of the present disclosure.

FIG. 4 is a perspective view illustrating a magazine applied to the array device for a hairpin type stator coil according to some example embodiments of the present disclosure.

FIG. 5 is a perspective view illustrating a magazine stack part applied to the array device for a hairpin type stator coil according to some example embodiments of the present disclosure.

FIGS. 6 and 7 are perspective views illustrating a magazine door opening/closing part applied to the array device for a hairpin type stator coil according to some example embodiments of the present disclosure.

FIG. 8 and FIG. 9 are overall perspective views illustrating a buffer unit applied to the array device for a hairpin type stator coil according to some example embodiments of the present disclosure.

FIG. 10 is a partial perspective view illustrating the buffer unit applied to the array device for a hairpin type stator coil according to some example embodiments of the present disclosure.

FIG. 11 is an overall perspective view illustrating a cartridge unit applied to the array device for a hairpin type stator coil according to some example embodiments of the present disclosure.

FIGS. 12 and 13 are perspective views illustrating the cartridge unit applied to the array device for a hairpin type stator coil according to some example embodiments of the present disclosure.

FIG. 14 is a view illustrating a tilting stopper portion of the cartridge unit applied to the array device for a hairpin type stator coil according to some example embodiments of the present disclosure.

FIG. 15 is a perspective view illustrating a part of the cartridge unit applied to the array device for a hairpin type stator coil according to some example embodiments of the present disclosure.

FIG. 16 is a view illustrating a coil clamper and an upper leg guide module of the cartridge unit applied to the array device for a hairpin type stator coil according to some example embodiments of the present disclosure.

FIG. 17 is a view illustrating a lower leg guide module of the cartridge unit applied to the array device for a hairpin type stator coil according to some example embodiments of the present disclosure.

FIG. 18 is a perspective view illustrating a coil insertion unit applied to the array device for a hairpin type stator coil according to some example embodiments of the present disclosure.

FIG. 19 is a perspective view illustrating a jig docking part applied to the array device for a hairpin type stator coil according to some example embodiments of the present disclosure.

FIG. 20 is a perspective view illustrating an array jig applied to the array device for a hairpin type stator coil according to some example embodiments of the present disclosure.

FIG. 21 is a plan view illustrating the array jig applied to the array device for a hairpin type stator coil according to some example embodiments of the present disclosure.

It should be understood that the drawings referenced above are not necessarily drawn to scale, and present rather simplified representations of various preferred features illustrating the basic principles of the present disclosure. For example, specific design features of the present disclosure, including specific dimensions, direction, position, and shape, will be determined in part by specific intended applications and use environments.

### DETAILED DESCRIPTION OF THE EMBODIMENTS

The present disclosure will be described more fully hereinafter with reference to the accompanying drawings, in which example embodiments of the disclosure are shown. As those skilled in the art would realize, the described example embodiments may be modified in various different ways, all without departing from the spirit or scope of the present disclosure.

A description for contents that are not associated with the present disclosure will be omitted in order to clearly describe the present disclosure, and like reference numerals designate like elements throughout the specification.

In addition, the size and thickness of each component illustrated in the drawings are arbitrarily illustrated for convenience of description, so the present disclosure is not necessarily limited to what is illustrated in the drawings, and the thickness is enlarged to clearly express various parts and areas.

The terminology used herein is for the purpose of describing particular embodiments and is not intended to limit the disclosure. As used herein, singular forms are intended to also include plural forms, unless the context clearly dictates otherwise.

The terms ‘comprises’ and/or ‘comprising’ as used herein indicate the presence of specified features, integers, steps, operations, elements, and/or components, but should also be understood as not excluding the presence or addition of one or more other features, integers, steps, operations, components, and/or groups thereof.

And, as used herein, the term ‘coupled’ denotes a physical relationship between two components in which the components are directly connected to each other or indirectly connected through one or more intermediary components.

Additionally, as used herein, the term “operably connected” or similar terms means that at least two members are directly or indirectly connected to each other so as to be capable of transmitting power. However, two operatively connected members do not always rotate at the same speed and in the same direction.

Furthermore, the terms ‘vehicle’, ‘of vehicle’, ‘automobile’ or other similar terms used herein generally include passenger automobiles including a passenger vehicle, a sports utility vehicle (SUV), a bus, a truck, and various commercial vehicles, and such automobiles may include hybrid automobiles equipped with a high-voltage battery, an electric vehicle, a hybrid electric vehicle, an electric vehicle-based purpose built vehicle (PBV), and a hydrogen-powered vehicle (also commonly referred to as ‘hydrogen electric vehicle’ by those skilled in the art).

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

As used herein, the term “hairpin-type stator coil” refers to an electrically conductive coil having a substantially U-shaped or hairpin0like geometry, typically including two elongated legs extending from bent or curved portion. Such coils are commonly used in electric motor or generator stators, where multiple hairpin coils are inserted around a stator core to form windings.

As used herein, the term “leg portion” of a hairpin-type stator coils refers to one of the two elongated sections that extend from the bent region of the coil. Likewise, “head portion” refers to the curved bent, or top region of the coil that bridges the two leg portions.

As used herein, the term “set posture” refers to the desired orientation or alignment of each hairpin-type stator coil at a particular stage of handling, buffering, or insertion.

As used herein, the term “seesaw-type link member” refers to any linkage mechanism that transfers motion between two points in a pivoting or rocking manner.

Hereinafter, example embodiments of the present disclosure will be described in detail with reference to the accompanying drawings.

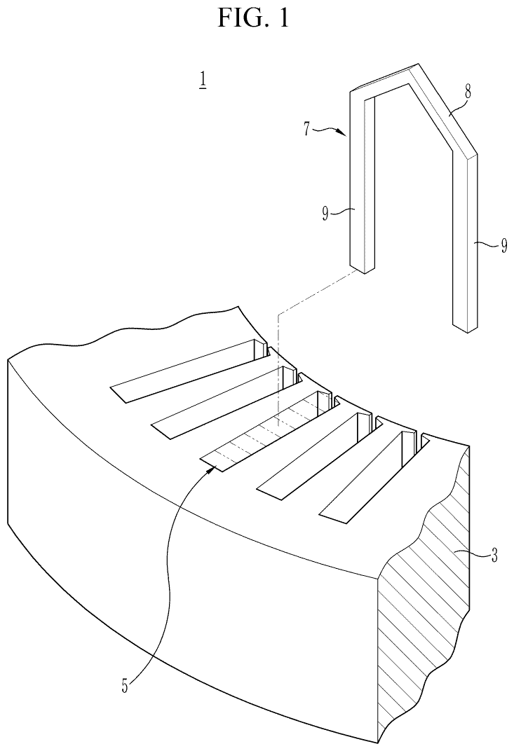

FIG. 1 is a schematic diagram illustrating an example of a hairpin winding type stator applied to some example embodiments of the present disclosure.

Referring to FIG. 1, first, a hairpin winding type stator 1 according to some example embodiments of the present disclosure may be applied to an eco-friendly automobile that obtains driving force from electric energy, for example, a drive motor for a hybrid vehicle and/or an electric automobile.

Here, the driving motor includes the stator 1 to which an example embodiment of the present disclosure is applied, and a rotor (not illustrated) arranged with a predetermined gap from the stator 1.

In the above, the stator 1 includes a stator core 3 in which a plurality of electrical steel plates is stacked. The stator core 3 is provided in a cylindrical shape having an outer diameter surface and an inner diameter surface.

The stator core 3 includes a plurality of slots 5 formed radially along a radial direction (e.g., an inner diameter direction).

A plurality of stator coils 7 formed in the hairpin type are wound around the slots 5 of the stator core 3. Those skilled in the art commonly refer to the stator coils 7 as conductor coils, segment coils, or flat coils.

For example, the stator coils 7 are formed in a U-shaped hairpin type and may be provided in a square cross-section shape. These stator coils 7 may include a head portion 8 and a pair of leg portions 9 connected to the head portion 8.

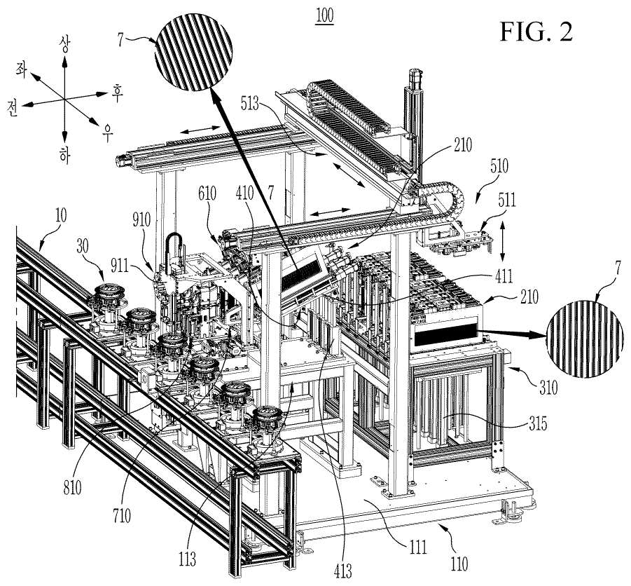

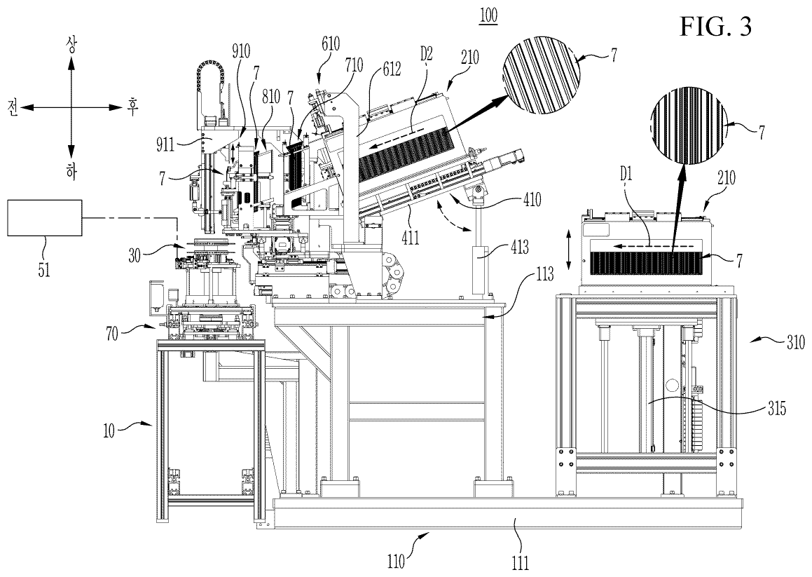

FIG. 2 is a perspective view illustrating an array device for a hairpin type stator coil according to some example embodiments of the present disclosure. FIG. 3 is a side view illustrating the array device for a hairpin type stator coil according to some example embodiments of the present disclosure.

Referring to FIGS. 2 and 3, an array device 100 for a hairpin type stator coil according to some example embodiments of the present disclosure may be applied to a process of manufacturing the hairpin winding type stator 1 (see FIG. 1).

The array device 100 for a hairpin type stator coil according to some example embodiments of the present disclosure may be applied to a process of inserting the stator coils 7 into the slots 5 (see FIG. 1) of the stator core 3 (see FIG. 1).

The array device 100 for a hairpin type stator coil according to some example embodiments of the present disclosure is configured to separately array (or quasi-array) the stator coils 7 before the process of inserting the stator coils 7 into the slots 5 of the stator core 3.

Here, the stator coils 7 arranged as described above are clamped by a clamper (not illustrated) and may be inserted into the slots 5 of the stator core 3 by the clamper.

In this specification, the reference direction for describing the following components may be set as a front-back direction, a left-right direction, and an up-down direction based on the drawing.

In addition, in this specification, ‘upper end portion’, ‘upper portion’, ‘upper end’, or ‘upper surface’ of a component refers to an end portion, a portion, an end, or a surface of a component located on a relatively upper side in the drawing, and ‘lower end portion’, ‘lower portion’, ‘lower end’, or ‘lower surface’ of the component refers to an end portion, a portion, an end, or a surface of a component located on a relatively lower side in the drawings.

Furthermore, in the present specification, an end (e.g., one end, another side (other side) end, etc.) of a component refers to an end of the component in any one direction, and an end portion (e.g., one end portion, another end (other end) portion, etc.) of a component refers to a certain portion of a component that includes that end.

Meanwhile, the array device 100 for a hairpin type stator coil according to some example embodiments of the present disclosure is configured to array (or insert) the stator coils 7 in array jigs 30 that are transported in a set transport direction (e.g., left-right direction) through a conveyor 10.

The configuration and operation of such array jigs 30 will be described in detail later.

The array device 100 for a hairpin type stator coil according to some example embodiments of the present disclosure absorbs a dispersion of shapes of the stator coils 7 and provides a structure capable of arraying the stator coils 7 in the array jigs 30 at high speed.

To this end, the array device 100 for a hairpin type stator coil according to some example embodiments of the present disclosure includes a frame 110, magazines 210, a magazine stack part 310, a magazine tilting part 410, a magazine loading unit 510, magazine door opening/closing parts 610, buffer units 710, cartridge units 810, and a coil insertion unit 910.

For example, the frame 110 may be fixed to a bottom surface of a process work site or may be provided to be movable to an arbitrary position on the bottom surface.

The frame 110 is configured to mount various components to be described below. The frame 110 may be composed of one frame or two or more frames.

The frame 110 may include various accessory elements such as brackets, bars, rods, plates, housings, cases, blocks, and bulkheads that are designed to support each component.

However, since the above-described various accessory elements are for mounting each component to be described below on the frame 110, for example, except for exceptional cases, the above-described various accessory elements are collectively referred to as the frame 110.

Here, the frame 110 includes a base frame 111 and a mounting frame 113 mounted on the base frame 111.

The base frame 111 may be mounted with a magazine stack part 310 and a magazine loading unit 510, which will be described below.

The magazine tilting part 410, the magazine door opening/closing part 610, the buffer unit 710, the cartridge unit 810, and the coil insertion unit 910, which will be described later, may be mounted on the mounting frame 113.

In some example embodiments of the present disclosure, each of the magazines 210 is configured to load (or store) the stator coils 7 of different shapes along a set loading direction D1.

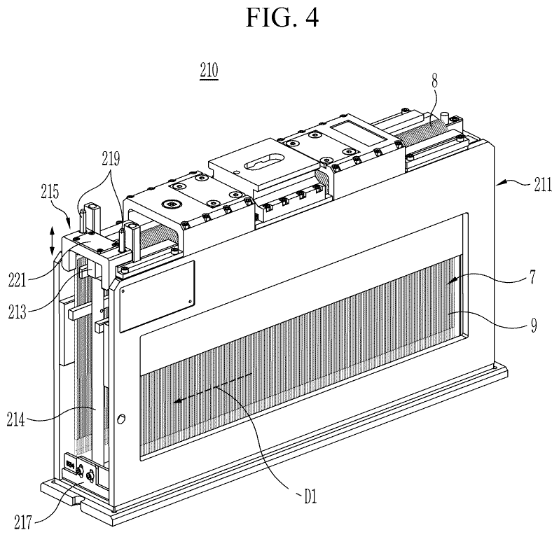

FIG. 4 is a perspective view illustrating a magazine applied to the array device for a hairpin type stator coil according to some example embodiments of the present disclosure.

Referring to FIG. 4, each of the magazines 210, for example, includes a magazine case 211, a guide bar 213, a door block 215, and a leg stopper 217.

The magazine case 211 is configured to form a space for loading the stator coils 7. The guide bar 213 is configured to support the head portion 8 of the stator coils 7 along the loading direction D1.

The guide bar 213 is arranged along the front-back direction, i.e., the loading direction D1, on an inner upper portion of the magazine case 211.

The guide bar 213 is coupled to at least one support bar 214 arranged along an up-down direction on a front inner side and a rear inner side of the magazine case 211, respectively.

The door block 215 is configured to block the head portion 8 of the stator coils 7.

The door block 215 is mounted on a front upper portion of the magazine case 211. The door block 215 may move in an up-down direction by a pair of guide pins 219 coupled to a front upper portion of the magazine case 211.

Furthermore, a steel magnetic attachment block 221 is coupled to an upper portion of the door block 215.

The leg stopper 217 is configured to block the leg portions 9 of the stator coils 7. The leg stopper 217 is mounted on a front lower portion of the magazine case 211.

Referring to FIGS. 2 and 3, in some example embodiments of the present disclosure, the magazine stack part 310 is configured to load the magazines 210.

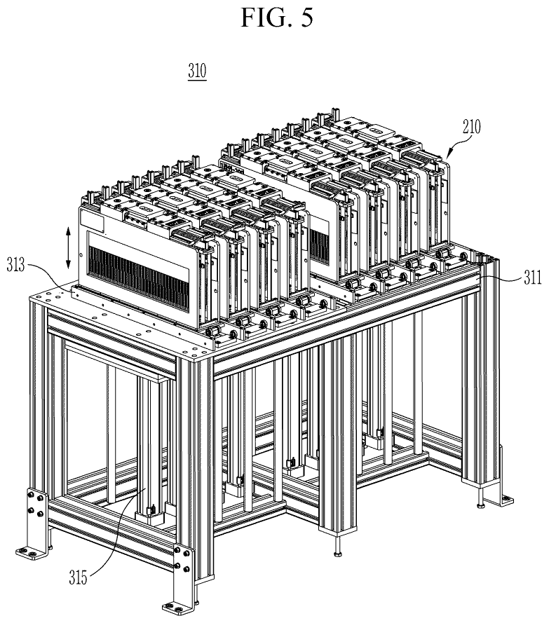

FIG. 5 is a perspective view illustrating a magazine stack part applied to the array device for a hairpin type stator coil according to some example embodiments of the present disclosure.

Referring to FIG. 5, the magazine stack part 310, for example, includes a stack frame 311, magazine support blocks 313, and lift cylinders 315.

The stack frame 311 is mounted on the base frame 111 (see FIGS. 1 and 2).

The magazine support blocks 313 are configured to support lower portions of the magazines 210. The magazine support blocks 313 are arranged along a front-back direction on an upper portion of the stack frame 311 and are installed in the stack frame 311 so as to be movable in the up-down direction.

The lift cylinders 315 are configured to move the magazine support blocks 313 in the up-down direction.

Each of the lift cylinders 315 is operatively connected to each of the magazine support blocks 313. For example, each of the lift cylinders 315 may include the pneumatic cylinder.

Referring to FIGS. 2 and 3, in some example embodiments of the present disclosure, the magazine tilting part 410 is configured to tilt the magazines 210 moved from the magazine stack part 310 in an inclination direction D2 that is inclined downward from the rear to the front.

The magazine tilting part 410 is arranged in front of the magazine stack part 310 and is installed in the mounting frame 113.

The magazine tilting part 410 includes tilt bases 411 and tilt cylinders 413.

The tilt bases 411 are coupled to the lower portions of the magazines 210 and are mounted on the mounting frame 113 so as to be tilt-rotatably mounted in the up-down direction.

The tilt cylinders 413 are configured to tilt-rotate the tilt bases 411 in the up-down direction.

Each of the tilt cylinders 413 is operatively connected to each of the tilt bases 411. For example, each of the tilt cylinders 413 may include the pneumatic cylinder.

Referring to FIG. 2, in some example embodiments of the present disclosure, the magazine loading unit 510 is configured to load the magazines 210 lifted upward by the lift cylinders 315 in the magazine stack part 310 onto the tilt bases 411 of the magazine tilting part 410.

The magazine loading unit 510 is installed on the base frame 111. The magazine loading unit 510 includes a magazine gripper 511.

The magazine gripper 511 is operatively connected to a multi-axis driver 513 installed on the base frame 111.

The magazine gripper 511 is configured to grip or un-grip the magazines 210 while moving in a multi-axis direction by driving the multi-axis driver 513.

Here, the magazine gripper 511 may move in the front-back direction, the left-right direction, and the up-down direction by driving the multi-axis driver 513.

For example, the multi-axis driver 513 includes a plurality of rails each extending in the front-back direction, the left-right direction, and the up-down direction, and the magazine gripper 511 or one rail may move in an extended direction on the other rail.

Since the multi-axis driver 513 capable of moving the magazine gripper 511 in the front-back direction, the left-right direction, and the up-down direction is well known to those skilled in the art, a further detailed description thereof will be omitted.

In addition, since the magazine gripper 511 for gripping or ungripping the magazines 210 is well known to those skilled in the art, a further detailed description thereof will be omitted.

Accordingly, the magazine gripper 511 moves toward the magazine stack part 310 by the driving of the multi-axis driver 513, grips the magazines 210 lifted upward from the magazine stack part 310, and may unload the magazines 210 from the magazine stack part 310.

The magazine gripper 511 as described above may move toward the magazine tilting part 410 by the driving of the multi-axis driver 513, ungripping the magazines 210 on the tilt bases 411 of the magazine tilting part 410 and loading the magazines 210 onto the tilt bases 411.

Referring to FIGS. 2 and 3, for example, the magazine door opening/closing parts 610 are configured to open and close the door blocks 215 (see FIG. 4) of the magazines 210 that are inclined downward from the rear to the front by the magazine tilting part 410.

The magazine door opening/closing parts 610 are installed on the post 612 mounted on the mounting frame 113.

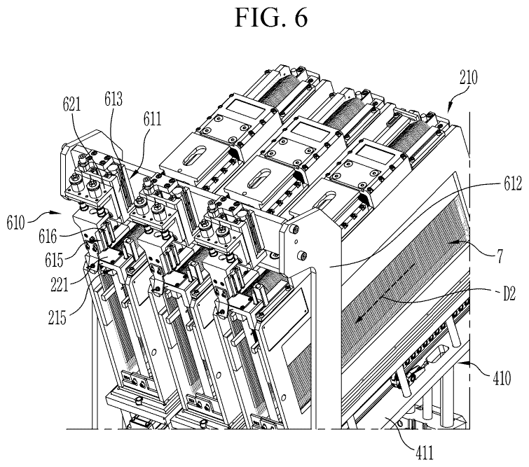

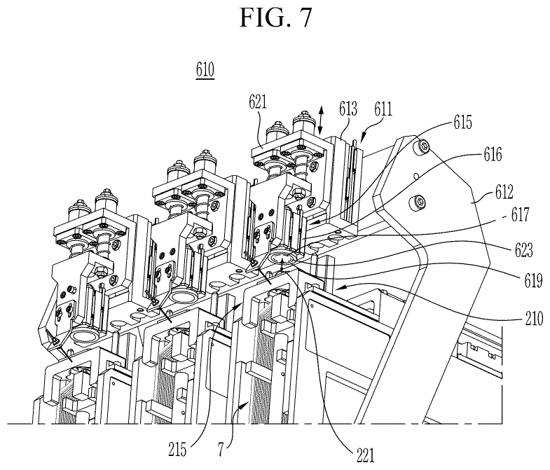

FIGS. 6 and 7 are perspective views illustrating a magazine door opening/closing part applied to the array device for a hairpin type stator coil according to some example embodiments of the present disclosure.

Referring to FIGS. 6 and 7, each of the magazine door opening/closing parts 610, for example, includes a main opening/closing cylinder 611, a moving block 613, a sub-opening/closing cylinder 615, a magnet member 617, and a spacer pad 619.

The main opening/closing cylinder 611 is fixed to an upper portion of the post 612. For example, the main opening/closing cylinder 611 may include the pneumatic cylinder.

The moving block 613 is operatively connected to the main opening/closing cylinder 611 and may move forward and backward in the up-down direction through the rail by the operation of the main opening/closing cylinder 611.

The sub-opening/closing cylinder 615 is installed to the moving block 613 through the mounting block 621. For example, the sub-opening/closing cylinder 615 may include the pneumatic cylinder.

The sub-opening/closing cylinder 615 includes an operating rod 623 that is moveable forward and backward in the up-down direction.

The magnet member 617 is mounted (e.g., built-in) to an end portion of the operating rod 623 of the sub-opening/closing cylinder 615.

The spacer pad 619 is fixed to the cylinder body 616 of the sub-opening cylinder 615 so that the operating rod 623 of the sub-opening cylinder 615 penetrates therethrough. For example, the spacer pad 619 may be provided as a ring-shaped pad made of rubber.

Here, the magnet member 617 may be magnetically coupled to the steel magnet attach block 221 mounted on the upper portion of the door block 215.

Referring to FIGS. 2 and 3, for example, the buffer units 710 are configured to extract the stator coils 7 loaded onto the magazine 210 one by one, and load and extract the set number of stator coils 7.

Here, the buffer units 710 may extract the stator coils 7 loaded onto the magazine 210 one by one while the door blocks 215 (see FIG. 7) of the magazines 210, which are tilted along the inclination direction D2 by the magazine tilting part 410, are opened by the magazine door opening/closing parts 610.

The buffer units 710 are arranged in front of the magazine tilting part 410 and are installed in the mounting frame 113.

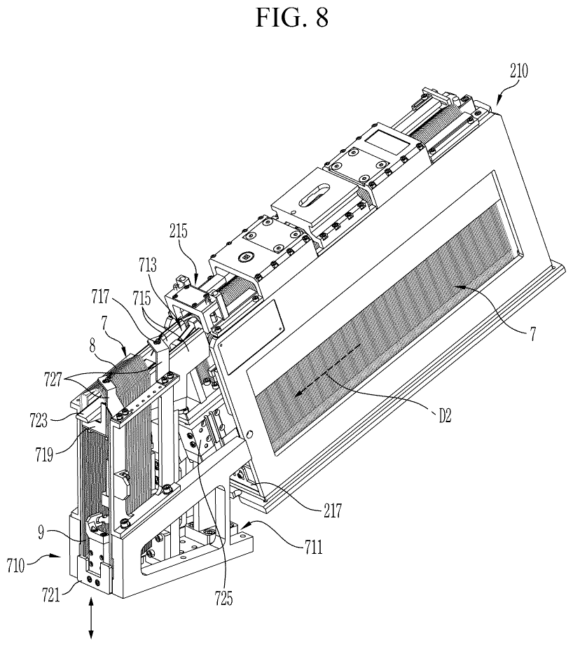

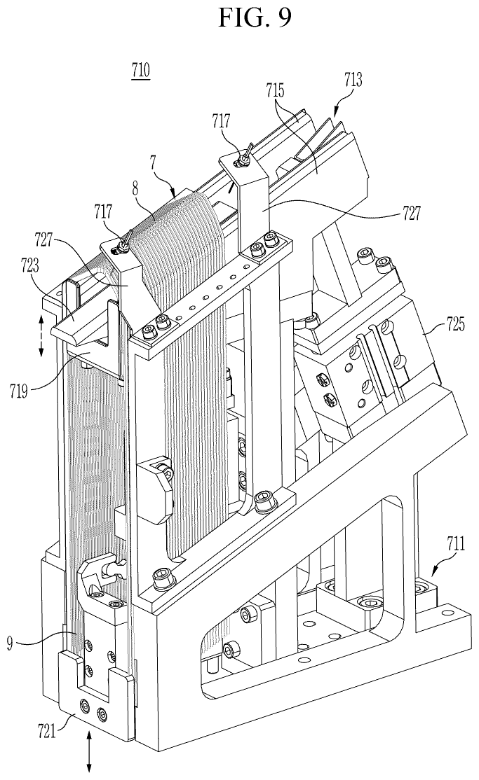

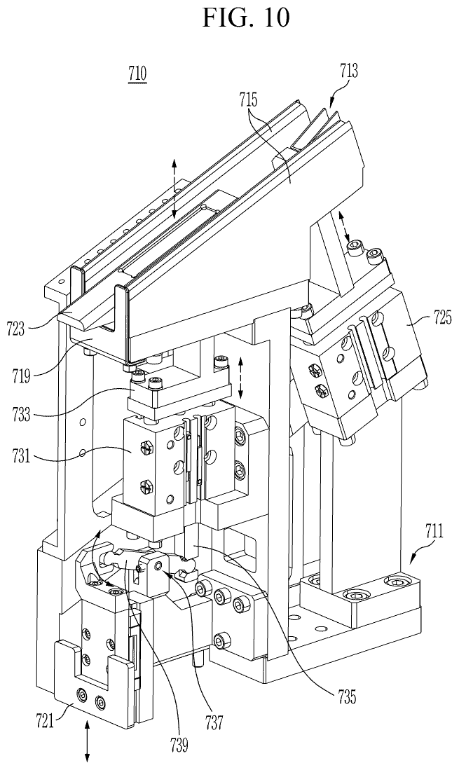

FIG. 8 and FIG. 9 are overall perspective views illustrating a buffer unit applied to the array device for a hairpin type stator coil according to some example embodiments of the present disclosure. FIG. 10 is a partial perspective view illustrating the buffer unit applied to the array device for a hairpin type stator coil according to some example embodiments of the present disclosure.

Referring to FIGS. 8 to 10, each of the buffer units 710, for example, includes a buffer body 711, a magazine coil extraction part 713, a pair of buffer fixed guiders 715, a coil detection sensor 717, an upper stopper 719, a lower stopper 721, and a buffer movable guider 723.

Here, when the door block 215 of the magazines 210 is opened as described above, the stator coils 7 loaded onto the magazines 210 may be stopped by the buffer fixed guiders 715, which will be described later.

The buffer body 711 is arranged along the front-back direction and is fixed to the mounting frame 113 (see FIG. 3).

The magazine coil extraction part 713 is configured to extract the stator coils 7 loaded onto the magazines 210 one by one along the inclination direction D2 of the magazines 210.

The magazine coil extraction part 713 is operatively connected to a first buffer cylinder 725 installed in the buffer body 711. For example, the first buffer cylinder 725 may include the pneumatic cylinder.

The magazine coil extraction part 713 may move forward and backward in the up-down direction perpendicular to the inclination direction D2 of the magazines 210 by operation of the first buffer cylinder 725.

The magazine coil extraction part 713 is arranged obliquely along the inclination direction D2 of the magazines 210.

Therefore, as described above, while the stator coils 7 loaded onto the magazines 210 are stopped by the buffer fixed guiders 715, the magazine coil extraction part 713 moves forward in the upward direction by the operation of the first buffer cylinder 725.

Then, among the stator coils 7 stopped by the buffer fixed guiders 715, one stator coil 7 positioned at the frontmost position is lifted upward by the magazine coil extraction part 713.

Therefore, the one stator coil 7 may deviate from the leg stopper 217 of the magazines 210 and extracted from the magazines 210 while sliding along the magazine coil extraction part 713 in the inclination direction D2 of the magazines 210.

The buffer fixed guider 715 is configured to support the stator coils 7 loaded onto the magazines 210 as described above. In addition, the buffer fixed guider 715 is configured to guide the set number of stator coils 7 extracted one by one by the magazine coil extraction part 713 along the inclination direction D2 and load the stator coils onto the buffer body 711.

The buffer fixed guiders 715 are fixed to an upper portion of the buffer body 711 with the magazine coil extraction part 713 therebetween and is arranged to be inclined along the inclination direction D2 of the magazines 210.

The coil detection sensor 717 is configured to detect the number of stator coils 7 loaded onto the buffer fixed guider 715.

The coil detection sensor 717 is installed on the buffer body 711 through the sensor bracket 727. For example, the coil detection sensor 717 is provided as a pair and may be respectively arranged at positions corresponding to a front portion and a middle portion of the buffer fixed guider 715.

Since the coil detection sensor 717 is well known to those skilled in the art as a sensor that outputs and inputs a detection source such as an infrared ray, a detailed description thereof will be omitted.

The upper stopper 719 is configured to support (or stop) the head portion 8 of the stator coils 7 loaded onto the buffer fixed guider 715. The upper stopper 719 is mounted on a front upper portion of the buffer body 711.

The lower stopper 721 is configured to support the leg portions 9 of the stator coils 7 loaded onto the buffer fixed guider 715. The lower stopper 721 is installed on the lower portion of the buffer body 711 so as to be able to move in the up-down direction through the rail.

The operating structure of the lower stopper 721 will be described in detail later together with the buffer movable guider 723.

The buffer movable guider 723 is configured to extract the set number of stator coils 7 loaded onto the buffer fixed guiders 715 from the buffer body 711.

The buffer movable guider 723 is arranged between the buffer fixed guiders 715 and is operatively connected to the second buffer cylinder 731 installed on the buffer body 711. The buffer movable guider 723 is arranged to be inclined along the inclination direction D2 of the magazines 210.

For example, the second buffer cylinder 731 may include the pneumatic cylinder. The buffer movable guider 723 is coupled to a buffer movable block 733 connected to the second buffer cylinder 731.

The buffer movable guider 723 may move forward and backward in the up-down direction perpendicular to the inclination direction D2 of the magazines 210 through the buffer movable block 733 by the operation of the second buffer cylinder 731.

Here, the buffer movable guider 723 may move forward to a position higher than the upper stopper 719 by the operation of the second buffer cylinder 731. That is, the buffer movable guider 723 may move upward to deviate from the upper stopper 719.

Meanwhile, the buffer movable block 733 is coupled to a connection block 735 along the up-down direction.

The connection block 735 and the lower stopper 721 described above are link-coupled to a seesaw type link member 737 installed on the buffer body 711.

The link member 737 includes a link bar 739 that is connected to the buffer body 711 so as to be swing-rotatably coupled in a seesaw type along the front-back direction.

A front-end portion of the link bar 739 is link-coupled to the lower stopper 721, and a rear end portion of the link bar 739 is link-coupled to a lower end portion of the connection block 735.

Therefore, the set quantity of stator coils 7 are loaded onto the buffer fixed guiders 715, and the buffer movable guider 723 moves forward in the upward direction through the buffer movable block 733 by the operation of the second buffer cylinder 731 while stopped by the upper stopper 719 and the lower stopper 721.

Then, the stator coils 7 loaded onto the buffer fixed guiders 715 are lifted upward by the buffer movable guider 723.

Here, the buffer movable guider 723 moves to a higher position than the upper stopper 719 by the operation of the second buffer cylinder 731.

In addition, since the connection block 735 connected to the buffer movable block 733 and the lower stopper 721 are link-coupled to the seesaw type link member 737, when the buffer movable block 733 is raised by the operation of the second buffer cylinder 731, the lower stopper 721 moves downward.

Thereby, the stator coils 7 loaded onto the buffer fixed guiders 715 may be extracted from the buffer body 711 while sliding along the buffer movable guider 723 in the inclination direction D2 of the magazines 210.

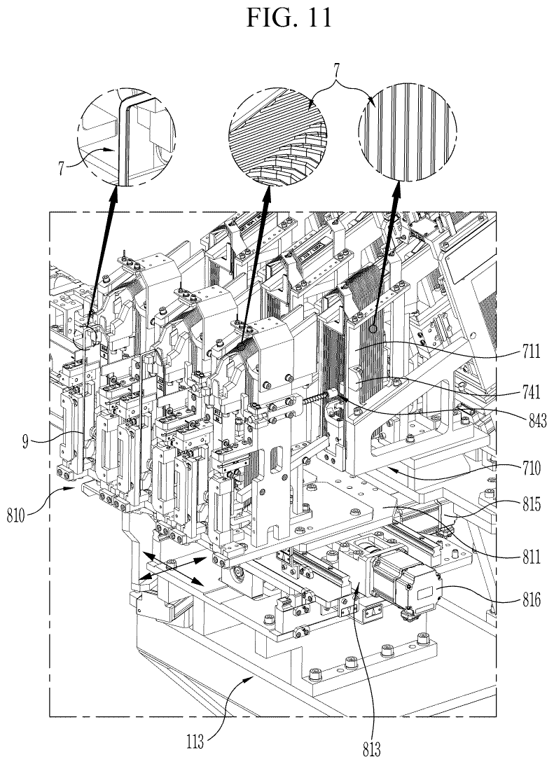

FIG. 11 is an overall perspective view illustrating a cartridge unit applied to the array device for a hairpin type stator coil according to some example embodiments of the present disclosure.

Referring to FIG. 11, for example, the cartridge units 810 are configured to load the stator coils 7 extracted from buffer units 710 and extract the stator coils 7 one by one. In addition, the cartridge units 810 are configured to maintain the set posture of the leg portions 9 of the extracted stator coils 7.

The cartridge units 810 are arranged in front of the buffer units 710 and are mounted on the mounting frame 113 so as to be movable in the front-back direction and left-right direction.

The cartridge units 810 may be mounted on a movable member 811 installed on the mounting frame 113 so as to be movable in the front-back direction and left-right direction.

The movable member 811 is operatively connected to a cartridge driver 813 installed on the mounting frame 113. The movable member 811 is installed on the mounting frame 113 so as to be movable in the front-back direction and left-right direction by the operation of the cartridge driver 813.

Here, the cartridge driver 813 includes servo motors 815 and 816 arranged in the front-back direction and the left-right direction, respectively. The servo motors 815 and 816 may be provided as motors capable of servo control of the rotational direction and rotational speed.

The cartridge driver 813 may include a lead screw and a guide mechanism that convert the rotational motion of the servo motors 815 and 816 into the linear motion.

Since the cartridge driver 813 capable of moving the movable member 811 in the front-back direction and the left-right direction is well known to those skilled in the art, a detailed description thereof will be omitted.

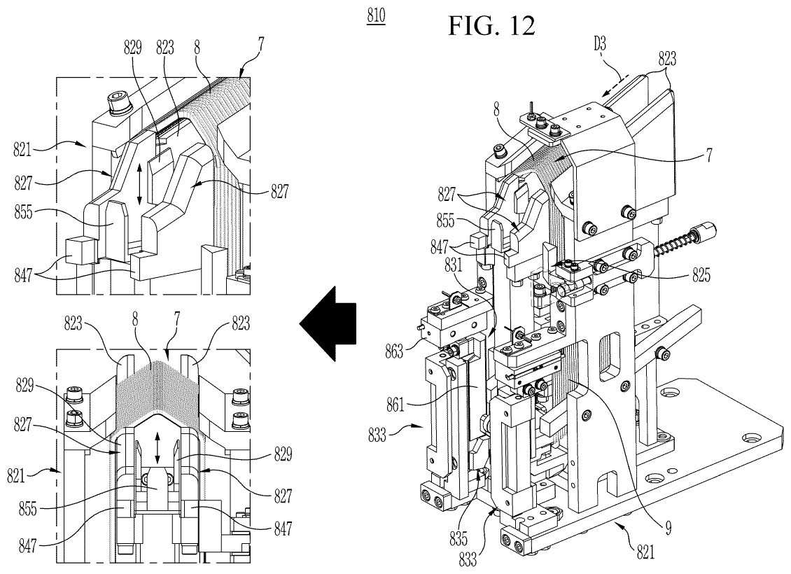

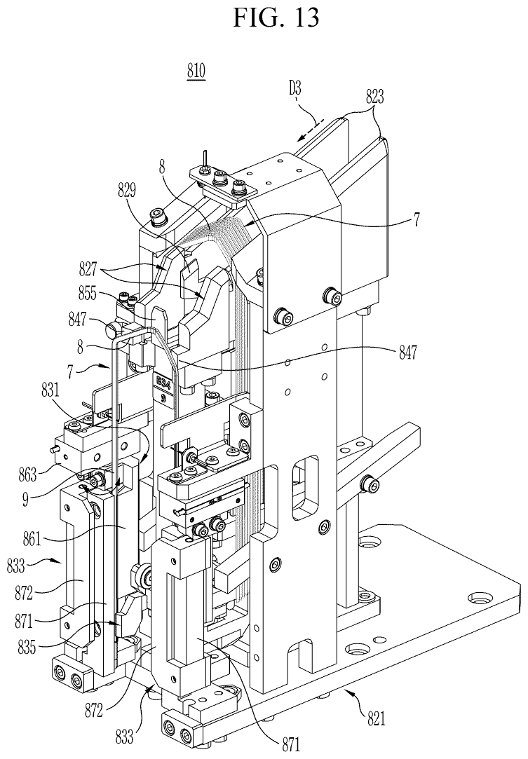

FIGS. 12 and 13 are perspective views illustrating the cartridge unit applied to the array device for a hairpin type stator coil according to some example embodiments of the present disclosure.

Referring to FIGS. 11 to 13, each of the cartridge units 810, for example, includes a cartridge body 821, a pair of first cartridge fixing guiders 823, a tilting stopper 825, a pair of second cartridge fixing guiders 827, a pair of cartridge movable guiders 829, a pair of coil clampers 831, a pair of upper leg guide modules 833, and a pair of lower leg guide modules 835.

The cartridge body 821 is mounted on the above-described movable member 811.

The first cartridge fixing guiders 823 are configured to load the set number of stator coils 7 extracted from the buffer units 710.

The first cartridge fixing guiders 823 are fixed to an upper portion of the cartridge body 821 so as to be inclined along the front-back direction. The first cartridge fixing guiders 823 are arranged along the inclination direction D3 that is inclined downward from the rear to the front.

The stator coils 7 extracted from the buffer units 710 may be loaded onto the first cartridge fixing guiders 823 while sliding along the first cartridge fixing guiders 823 in the inclination direction D3.

Here, the first cartridge fixing guiders 823 may be docked to the buffer units 710 as the moving member 811 moves toward the buffer units 710 along the front-back direction by the operation of the cartridge driver 813.

The first cartridge fixing guiders 823 may load the stator coils 7 extracted from the buffer units 710 while being docked to the buffer units 710.

Furthermore, the stator coils 7 loaded onto the first cartridge fixing guiders 823 may be stopped by the second cartridge fixing guiders 827 to be described later.

The tilting stopper 825 is configured to stop the stator coils 7 loaded onto the first cartridge fixing guiders 823 while supporting the stator coils 7 when the first cartridge fixing guiders 823 are docked to the buffer units 710.

The tilting stopper 825 is rotatably mounted on one side of both sides of the cartridge body 821.

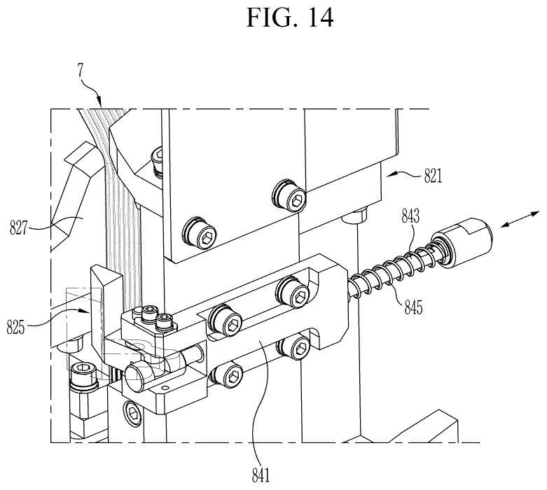

Referring to FIG. 14, the mounting structure of the tilting stopper 825 will be described. A support block 841 is mounted on one side of the cartridge body 821.

A slide bar 843 is mounted on the support block 841 so as to be movable in the front-back direction through a spring 845.

The slide bar 843 is in a state where it moves to the rear side by the elastic force of the spring 845 when the first cartridge fixing guiders 823 are not docked to the buffer units 710.

In addition, the slide bar 843 may move to the front side by overcoming the elastic force of the spring 845 when the first cartridge fixing guiders 823 are docked to the buffer units 710.

To this end, as illustrated in FIG. 11, a docking block 741 is mounted on the buffer body 711 of the buffer units 710. The docking block 741 is mounted on one side of the buffer body 711 at a position corresponding to the slide bar 843.

Meanwhile, the tilting stopper 825 as described above is tilt-rotatably coupled to the support block 841 and is jointly coupled to a front-end portion of the slide bar 843.

Here, when the first cartridge fixing guiders 823 are not docked to the buffer units 710, since the slide bar 843 moves backward by the elastic force of the spring 845, the tilting stopper 825 is maintained in a state of tilting and rotating forward to allow the extraction of the stator coils 7.

When the first cartridge fixing guiders 823 are docked to the buffer units 710, since the slide bar 843 is pressed by the docking block 741 and moves forward, the tilting stopper 825 is tilted and rotates forward to prevent the extraction of the stator coils 7.

The second cartridge fixing guiders 827 are configured to prevent the sliding of the stator coils 7 loaded onto the first cartridge fixing guiders 823 as described above. In addition, the second cartridge fixing guiders 827 are configured to support (or mount) one stator coil 7 extracted from the first cartridge fixing guiders 823.

The second cartridge fixing guiders 827 are connected to a front portion of the first cartridge fixing guiders 823. The second cartridge fixing guiders 827 are obliquely mounted to the cartridge body 821 along the inclination direction D3 of the first cartridge fixing guiders 823.

As illustrated in FIG. 12, the second cartridge fixing guiders 827 are arranged higher than the first cartridge fixing guiders 823. In addition, each of the second cartridge fixing guiders 827 is formed with a coil mounting protrusion 847.

The cartridge movable guiders 829 are configured to extract the stator coils 7 loaded onto the first cartridge fixed guiders 823 one by one and to seat one stator coil 7 on the second cartridge fixed guiders 827.

The cartridge movable guiders 829 are arranged between the second cartridge fixed guiders 827 and are arranged to be inclined along the inclination direction D3 of the first cartridge fixed guiders 823.

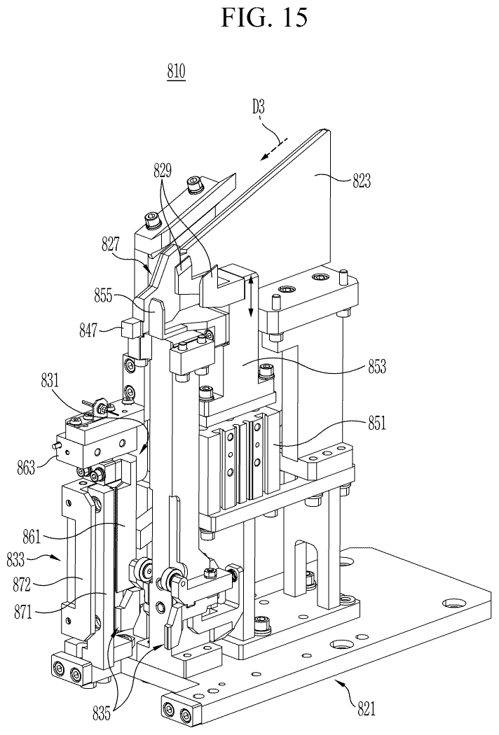

As illustrated in FIG. 15, the cartridge movable guiders 829 are operatively connected to the cartridge cylinder 851 installed in the cartridge body 821. For example, the cartridge cylinder 851 may include the pneumatic cylinder.

The cartridge movable guiders 829 are fixed to the cartridge movable block 853 connected to the cartridge cylinder 851.

The cartridge movable guiders 829 may move forward and backward in the up-down direction perpendicular to the inclination direction D3 of the first cartridge fixed guiders 823 through the cartridge movable block 853 by the operation of the cartridge cylinder 851.

Here, the cartridge movable guiders 829 may move forward to a higher position than the second cartridge fixed guiders 827 by the operation of the cartridge cylinder 851.

Furthermore, the cartridge movable block 853 is equipped with a head stopper 855 that is configured to support the head portion 8 of one stator coil 7 extracted from the first cartridge fixed guiders 823.

Therefore, the set number of stator coils 7 extracted from the buffer units 710 are loaded onto the first cartridge fixed guiders 823 and stopped by the second cartridge fixed guiders 827.

When the cartridge movable guiders 829 move upward by the operation of the cartridge cylinder 851, the stator coil 7 positioned at the frontmost position among the stator coils 7 is lifted upward by the cartridge movable guiders 829.

Here, one stator coil 7 is stopped by the head stopper 855 while sliding along the cartridge movable guiders 829.

In addition, when the cartridge movable guiders 829 move downward by the operation of the cartridge cylinder 851, one stator coil 7 is slid along the second cartridge fixed guiders 827 and is mounted on the coil mounting projection 847 of the second cartridge fixed guiders 827.

Referring to FIGS. 12 and 13, the coil clampers 831, for example, are configured to move one stator coil 7 mounted on the coil mounting projections 847 of the second cartridge fixing guiders 827 forward. In addition, the coil clampers 831 are configured to clamp the leg portions 9 of one stator coil 7.

The coil clampers 831 are arranged on both sides of a front portion of the cartridge body 821, respectively, and are rotatably installed in the cartridge body 821.

Each of the coil clampers 831 includes a clamp block 861. The clamp block 861 is operatively connected to a clamp driver 863 installed in the cartridge body 821. For example, the clamp driver 863 may include a servo motor capable of servo control of the rotation speed and rotation direction.

The clamp block 861 may swing and rotate along the front-back direction by the operation of the clamp driver 863 to move one stator coil 7 mounted on the coil mounting projections 847 of the second cartridge fixing guiders 827 to the front side.

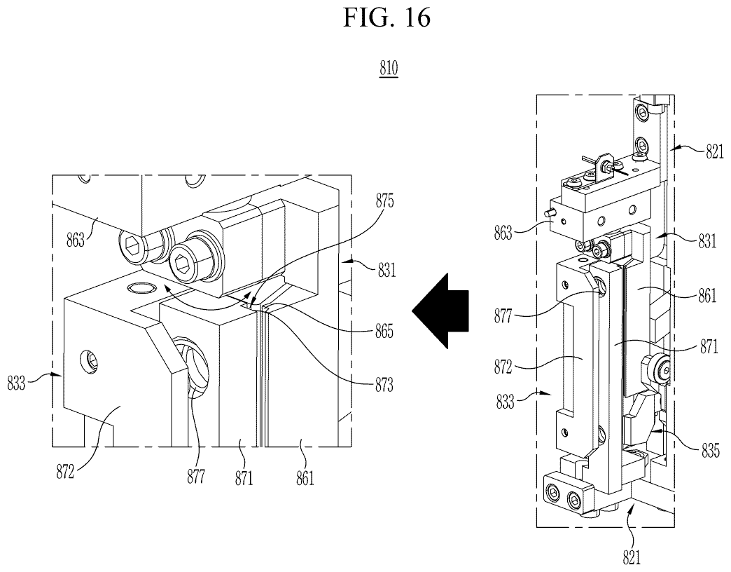

As illustrated in FIGS. 13 and 16, the clamp block 861 has a coil clamp groove 865 formed along the up-down direction to support and clamp the leg portions 9 of one stator coil 7.

Referring to FIGS. 12 and 13, for example, the upper leg guide modules 833 and the lower leg guide modules 835 are configured to support and guide the leg portions 9 of one stator coil 7 moving to the front side by the coil clampers 831.

The upper leg guide modules 833 are installed on both sides of the front portion of the cartridge body 821 in front of the coil clampers 831. The upper leg guide modules 833 are respectively arranged at positions corresponding to the clamp blocks 861 of the coil clampers 831.

As illustrated in FIGS. 13, 15, and 16, each of the upper leg guide modules 833 includes a fixed guide block 871 and a rotation guide block 872.

The fixed guide block 871 is arranged at a position corresponding to the clamp block 861 and is fixed to the cartridge body 821 along the up-down direction.

A rail groove 873 is formed in the fixed guide block 871 along the up-down direction to support the leg portions 9 of one stator coil 7. The rail groove 873 is formed at a position corresponding to the coil clamp groove 865 of the clamp block 861.

The above-described rotation guide block 872 is combined with the rail groove 873 of the fixed guide block 871 and forms a rail guide pocket 875 along the up-down direction.

The rotation guide block 872 is arranged along the up-down direction and is rotatably mounted on the fixed guide block 871. The rotation guide block 872 is connected to the fixed guide block 871 through a spring 877.

Here, one stator coil 7 moves forward by the coil clampers 831, and the leg portions 9 of one stator coil 7 are positioned in the rail guide pocket 875 and may be clamped by the clamp blocks 861 of the coil clampers 831.

Referring to FIGS. 12 and 13, the lower leg guide modules 835 are arranged between the upper leg guide modules 833 and are mounted on the cartridge body 821 so as to be movable in the front-back direction.

Referring to FIGS. 13, 15 and 17, each of the lower leg guide modules 835 includes a cam roller 883 and a leg guide block 885.

The cam roller 883 is arranged between the upper leg guide modules 833. The cam roller 883 is rotatably mounted on the cam block 881, which is mounted to the cartridge body 821 in the front-back direction through a spring 887.

The cam roller 883 is arranged on a front portion of the cam block 881 and is selectively coupled to a cam follower groove 884 formed on the cartridge body 821.

The leg guide block 885 is connected to the front portion of the cam block 881 through a spring 891 so as to contact the leg portions 9 of one stator coil 7 positioned in the rail guide pocket 875 (see FIG. 16) described above.

The leg guide block 885 is rotatably mounted on the cam block 881 in the left-right direction.

Referring to FIGS. 2 and 3, for example, the coil insertion unit 910 is configured to insert the stator coils 7 extracted one by one from the cartridge units 810 into the array jigs 30 described above.

That is, the coil insertion unit 910 may insert one stator coil 7, which is regulated by the coil clampers 831, the upper leg guide modules 833, and the lower leg guide modules 835 of the cartridge units 810, into the array jigs 30 along the up-down direction, as illustrated in FIG. 13.

The coil insertion unit 910 is arranged in front of the cartridge units 810 and is installed in the mounting bracket 911 fixed to the mounting frame 113.

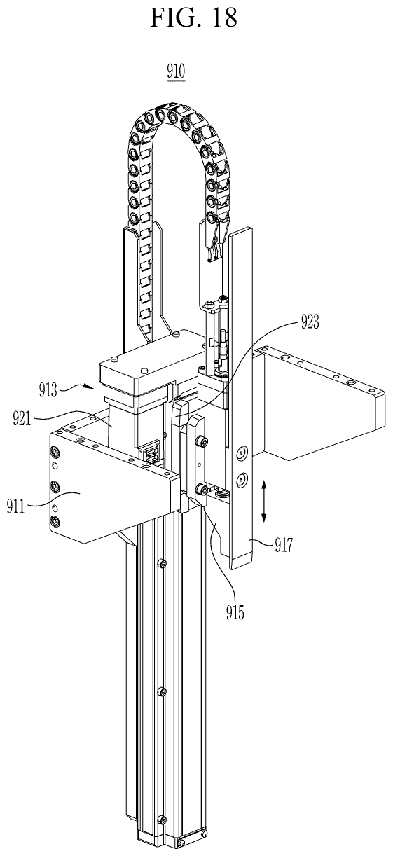

FIG. 18 is a perspective view illustrating a coil insertion unit applied to the array device for a hairpin type stator coil according to some example embodiments of the present disclosure.

Referring to FIGS. 3 and 18, the coil insertion unit 910, for example, includes a coil insertion driver 913, a push block 915, and a cam pusher 917.

The coil insertion driver 913 is installed in the mounting bracket 911 at a position corresponding to the array jigs 30.

For example, the coil insertion driver 913 may include a servo motor 921 capable of the servo control of the rotation speed and rotation direction.

The coil insertion driver 913 may include a lead screw that converts the rotational motion of the servo motor 921 into the linear motion and a lifting block 923 that moves in the up-down direction by a guide mechanism.

The push block 915 is configured to push one stator coil 7 regulated in the cartridge units 810 downward. The push block 915 is fixed to the lifting block 923.

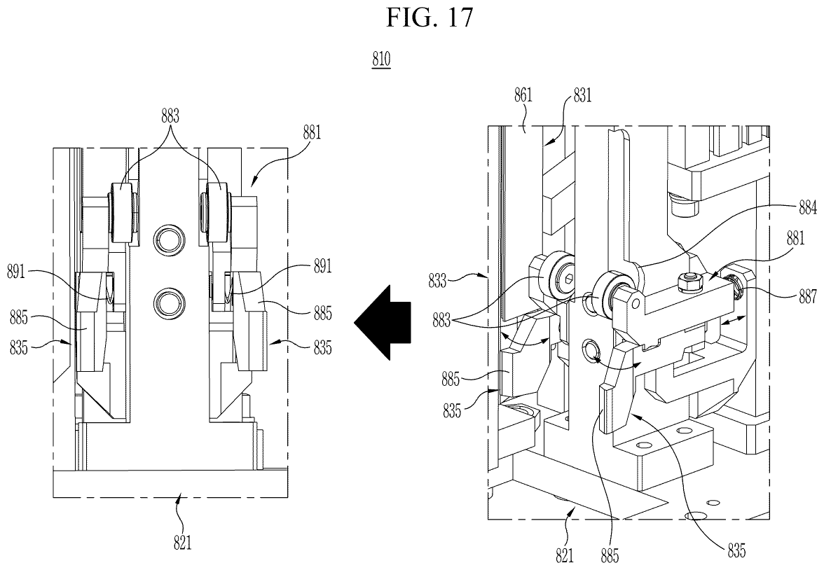

The cam pusher 917 is configured to push the cam roller 883 of the cartridge units 810 illustrated in FIG. 17. The cam pusher 917 is coupled to the push block 915.

Meanwhile, referring to FIG. 3, the array device 100 for a hairpin type stator coil according to some example embodiments of the present disclosure includes a jig docking part 70.

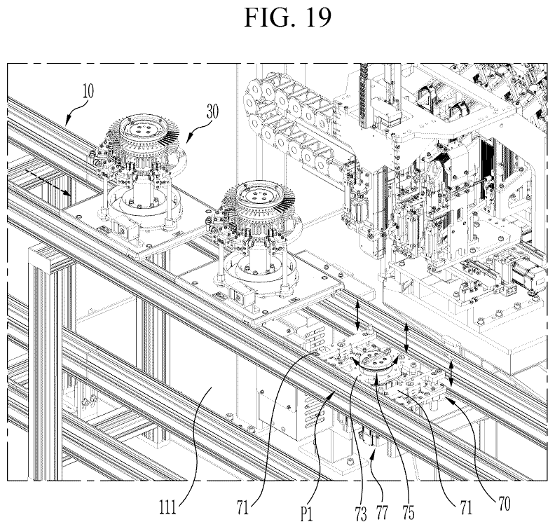

FIG. 19 is a perspective view illustrating a jig docking part applied to the array device for a hairpin type stator coil according to some example embodiment of the present disclosure.

Referring to FIGS. 3 and 19, for example, the jig docking part 70 is configured to dock one of the array jigs 30 transported through the conveyor 10 to the set docking point P1 of the conveyor 10.

Here, the set docking point P1 may be defined as a position corresponding to the coil insertion unit 910 described above.

The jig docking part 70 is installed on the base frame 111 at the docking point P1. The jig docking part 70 fixes one array jig 30 to the docking point P1 and may rotate one array jig 30.

The jig docking part 70 includes a first docking base 71, a second docking base 73, and a jig joint 75.

Each of the first docking base 71 and the second docking base 73 is operatively connected to a docking drive source 77. Each of the first docking base 71 and the second docking base 73 may move in the up-down direction by the operation of the docking drive source 77.

Here, the first docking base 71 and the second docking base 73 may be coupled to a lower portion of one array jig 30. The first docking base 71 is arranged on the front and rear sides according to the transport direction of the array jigs 30, respectively, and the second docking base 73 is arranged between the first docking bases 71.

The jig joint 75 is rotatably mounted on the second docking base 73. The jig joint 75 may rotate by the operation of the docking drive source 77.

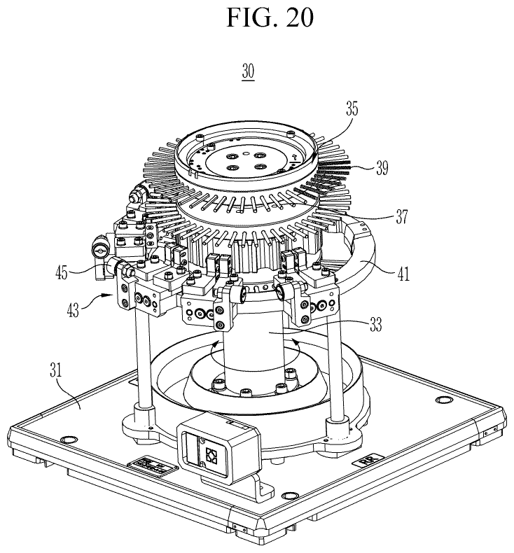

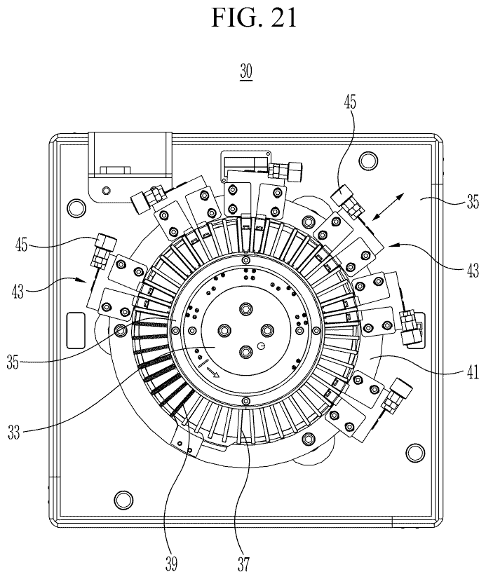

For example, the docking drive source 77 may include a plurality of servo motors capable of the servo control of the rotation speed and rotation direction, and a plurality of actuating cylinders operated by pneumatic pressure. FIG. 20 is a perspective view illustrating the array jig applied to the array device for a hairpin type stator coil according to some examples embodiment of the present disclosure, and FIG. 21 is a plan view illustrating the array jig applied to the array device for a hairpin type stator coil according to some example embodiments of the present disclosure.

FIG. 20 is a perspective view illustrating an array jig applied to the array device for a hairpin type stator coil according to some example embodiments of the present disclosure. FIG. 21 is a plan view illustrating the array jig applied to the array device for a hairpin type stator coil according to some example embodiments of the present disclosure.

Referring to FIGS. 3 and 19 to 21, for example, each of the array jigs 30 is configured to array the stator coils 7 inserted by the coil insertion unit 910.

Each of the array jigs 30 includes a jig base 31, a rotating member 33, fixed rings 35, and jig pins 37.

The jig base 31 may be coupled to a first docking base 71 of the jig docking part 70.

The rotating member 33 is rotatably mounted on the jig base 31. The rotating member 33 may be coupled to the jig joint 75 of the jig docking part 70.

The fixed rings 35 are coupled to the rotating member 33 at a set interval along the up-down direction. The fixed rings 35 may be arranged in a plurality of stages (for example, three stages) along the up-down direction on the rotating member 33.

The jig pins 37 are fixed to an outer surface of the fixed rings 35 and are radially arranged on an outer surface of the fixed rings 35 at a set interval.

Here, the jig pins 37 are configured to support the stator coils 7, and the interval between the jig pins 37 may be defined as an insertion space into which the stator coils 7 are inserted.

Furthermore, each of the array jigs 30, for example, may further include jig springs 39.

The jig springs 39 may be provided as coil springs supporting the stator coils 7. The jig springs 39 are radially arranged in a set outer circumference section of the fixed rings 35.

The jig springs 39 may buffer the load acting on the stator coils 7 and form a fluid space into which the stator coils 7 may be inserted.

Furthermore, each of the array jigs 30, for example, may further include a support ring 41 and coil pocket parts 43.

The support ring 41 is fixed to the jig base 31 with the fixed rings 35 arranged on the inside.

In addition, the coil pocket parts 43 guide an I-shaped stator coils, which are not illustrated in the drawing, and are configured to insert the I-shaped stator coils between the jig pins 37.

The coil pocket parts 43 are radially movably mounted on the support ring 41. The coil pocket parts 43 may be radially movably mounted on the support ring 41 by means of guide protrusions and springs (not illustrated) well known to those skilled in the art.

Each of the coil pocket parts 43 may include a cam member 45 in the form of a roller. The cam member 45 is configured to cam-contact with a pocket moving unit 51 as illustrated in FIG. 3.

The pocket moving unit 51 may cam-contact with the cam member 45 along the up-down direction to avoid the interference between the stator coils 7 arrayed on the jig pins 37 and the jig springs 39 and the coil pocket parts 43 and may move the coil pocket parts 43 outwardly from the radius of the support ring 41.

For example, the pocket moving unit 51 is installed on the conveyor 10 at the position corresponding to the jig docking part 70 and may move in the up-down direction by a separate drive source. In another example, the pocket moving unit 51 may include a wedge-shaped block that cam-contacts the cam member 45.

Hereinafter, the operation of the array device 100 for a hairpin type stator coil according to some example embodiments of the present disclosure configured as described above will be described in detail with reference to FIGS. 1 to 21.

First, the stator coils 7 formed in the coil forming process are provided. The stator coils 7 are stored along the loading direction D1 set in the magazines 210. Such the magazines 210 are loaded onto the magazine stack part 310.

For example, each of the stator coils 7 has a ‘U’ shape. Each of the stator coils 7 includes the head portion 8 and the pair of leg portions 9.

The stator coils 7 are loaded along a loading direction D1 on the guide bar 213 inside the magazine case 211. The door block 215 of the magazines 210 blocks the head portion 8 of the stator coils 7, and the leg stopper 217 blocks the leg portion 9.

One of the magazines 210 loaded onto the magazine stack part 310 is lifted upward by the operation of the lift cylinder 315. For example, the tilt bases 411 of the magazine tilting part 410 are in a state of being tilted and rotating in a horizontal direction by the operation of the tilt cylinders 413.

In this state, the magazine gripper 511 of the magazine loading unit 510 moves toward the magazine stack part 310 by the operation of the multi-axis driver 513. The magazine gripper 511 grips one magazine 210 lifted upward from the magazine stack part 310 and unloads the magazine 210 from the magazine stack part 310.

The magazine gripper 511 moves toward the magazine tilting part 410 by the operation of the multi-axis driver 513, ungrips the magazine 210 on the tilt bases 411 of the magazine tilting part 410 and loads the magazine 210 onto the tilt bases 411.

Accordingly, the magazine loading unit 510 repeats the operation as described above and may load the magazines 210 loaded onto the magazine stack part 310 onto the tilt bases 411 of the magazine tilting part 410.

Next, the tilt bases 411 tilt and rotate inclined downward from the rear to the front by the operation of the tilt cylinders 413. Then, the magazines 210 loaded onto the magazine tilting part 410 are tilted downward from the rear to the front in the inclination direction D2.

Thereby, the stator coils 7 loaded onto the magazines 210 slide along the guide bar 213 in the inclination direction D2, and are brought into close contact with each other, and are stopped by the door block 215 and the leg stopper 217. Accordingly, the stator coils 7 are maintained in a state of waiting for extraction from the magazines 210.

Then, the door blocks 215 of the magazine 210s are opened by the operation of the magazine door opening/closing parts 610.

Describing in detail the opening/closing process of the door block 215 by the magazine door opening/closing parts 610, first, the moving block 613 moves downward by the operation of the main opening/closing cylinder 611.

Then, the sub-opening/closing cylinder 615 coupled to the moving block 613 moves downward by the moving block 613. For example, the operating rod 623 of the sub-opening/closing cylinder 615 is in a backward movement state, and the spacer pad 619 is in a state of being closely attached to the magnetic attachment block 221 on the door block 215.

Then, the operating rod 623 moves forward in the downward direction by the operation of the sub-opening/closing cylinder 615. The operating rod 623 penetrates through the spacer pad 619.

Here, since the magnet member 617 is mounted on an end portion of the operating rod 623, the magnet member 617 is coupled to the magnet attachment block 221 by the magnetic force.

Then, the moving block 613 moves upward by the operation of the main opening/closing cylinder 611, and the sub-opening/closing cylinder 615 moves upward by the moving block 613.

Therefore, since the magnet attachment block 221 is coupled to the magnet member 617, the door block 215 is opened upward by the upward movement of the moving block 613.

Meanwhile, when the door blocks 215 of the magazines 210 are opened as described above, the stator coils 7 loaded onto the magazines 210 are stopped by the buffer fixed guiders 715 of the buffer units 710.

In addition, the magazine coil extraction part 713 of the buffer units 710 is in a state of being moved downward by the operation of the first buffer cylinder 725. The buffer movable guider 723 of the buffer units 710 is in a state of being moved downward by the operation of the second buffer cylinder 731.

Furthermore, the upper stopper 719 of the buffer units 710 is mounted on the front upper portion of the buffer body 711.

The buffer movable guider 723 is coupled to the buffer movable block 733 coupled to the second buffer cylinder 731, and the buffer movable block 733 is coupled to the connection block 735.

Here, the lower stopper 721 of the buffer units 710 and the connection block 735 are link-coupled to a seesaw type link member 737. Accordingly, as the buffer movable guider 723 moves downward, the lower stopper 721 moves upward by the link member 737.

In this state, the magazine coil extraction part 713 moves forward in the upward direction by the operation of the first buffer cylinder 725.

Then, the magazine coil extraction part 713 lifts one stator coil 7 upward, which is arranged at the frontmost position among the stator coils 7 stopped by the buffer fixed guiders 715.

Therefore, the one stator coil 7 is removed from the leg stoppers 217 of the magazines 210 and is extracted from the magazines 210 while sliding along the magazine coil extraction part 713 in the inclination direction D2 of the magazines 210.

As described above, one stator coil 7 extracted from the magazines 210 enters the buffer fixed guiders 715 and slides along the buffer fixed guiders 715 in the inclination direction D2 of the magazines 210 and is loaded onto the buffer fixed guiders 715.

When the one stator coil 7 is loaded onto the buffer fixed guiders 715, the magazine coil extraction part 713 moves downward again by the operation of the first buffer cylinder 725.

Therefore, when the process described above is repeated, the set number of stator coils 7 extracted one by one from the magazines 210 are loaded onto the buffer fixed guiders 715 along the inclination direction D2 of the magazines 210.

In this process, the coil detection sensor 717 of the buffer units 710 detects the number of stator coils 7 loaded onto the buffer fixed guiders 715.

Then, the stator coils 7 loaded onto the buffer fixed guiders 715 are maintained in the stopped state by the upper stopper 719 and the lower stopper 721.

As described above, in the state where the set number of stator coils 7 extracted from the magazines 210 are loaded onto the buffer units 710, the moving block 613 moves downward by the operation of the main opening/closing cylinder 611 of the magazine door opening/closing parts 610.

Then, the sub-opening/closing cylinder 615 coupled to the moving block 613 moves downward by the moving block 613.

Accordingly, the door block 215 coupled to the magnet member 617 of the operating rod 623 of the sub-opening cylinder 615 through the magnet attachment block 221 moves downward and returns to its original position.

Next, the operating rod 623 penetrates through the spacer pad 619 and moves backward in the upward direction by the operation of the sub-opening cylinder 615.

Thereby, the magnet member 617 is separated from the magnet attachment block 221 by the spacer pad 619. Then, the moving block 613 moves upward by the operation of the main opening cylinder 611, and the sub-opening cylinder 615 moves upward by the moving block 613.

On the other hand, the cartridge units 810 are in the state where they move forward by the moving member 811 by the operation of the cartridge driver 813.

Here, the tilting stopper 825 of the cartridge units 810 is maintained in the state where it is tilted and rotating toward the front side because the slide bar 843 moves toward the rear side by the elastic force of the spring 845.

In this state, the cartridge units 810 move toward the rear side through the moving member 811 by the operation of the cartridge driver 813 and docked to the buffer units 710.

Then, the slide bar 843 is pressed by the docking block 741 of the buffer units 710 and moves toward the front side, and the tilting stopper 825 tilts and rotates toward the rear side.

Furthermore, the cartridge movable guiders 829 of the cartridge units 810 are in the state where they move backward in the downward direction by the operation of the cartridge cylinder 851.

The clamp blocks 861 of the coil clampers 831 of the cartridge units 810 are in the state where it swings backward by the operation of the clamp driver 863.

The fixed guide blocks 871 and the rotation guide blocks 872 of the upper leg guide modules 833 of the cartridge units 810 form the rail guide pocket 875 along the up-down direction by the rail groove 873 of the fixed guide block 871.

The cam blocks 881 of the lower leg guide modules 835 of the cartridge units 810 are in a state where they move forward together with the cam roller 883 and the leg guide block 885 by the elastic force of the spring 887.

In this state, the buffer movable guider 723 of the buffer units 710 moves forward in the upper direction by the operation of the second buffer cylinder 731 and moves forward to a position higher than the upper stopper 719.

Accordingly, the stator coils 7 loaded onto the buffer fixed guiders 715 of the buffer units 710 are lifted upward by the buffer movable guider 723.

In this process, since the above-described connection block 735 and lower stopper 721 are link-coupled to the seesaw type link member 737, when the buffer movable block 733 rises by the operation of the second buffer cylinder 731, the lower stopper 721 moves downward.

Therefore, the stator coils 7 loaded onto the buffer fixed guiders 715 are extracted from the buffer body 711 while sliding along the buffer movable guider 723 in the inclination direction D2 of the magazine 210s.

In this way, the set number of stator coils 7 extracted from the buffer units 710s is loaded onto the first cartridge fixed guiders 823 while sliding along the first cartridge fixed guiders 823 of the cartridge units 810 in the inclination direction D3.

Here, the stator coils 7 loaded onto the first cartridge fixing guiders 823 are stopped by the second cartridge fixing guiders 827 and the tilting stopper 825.

Next, the cartridge units 810 move forward through the moving member 811 by the operation of the cartridge driver 813, and the docking with the buffer units 710 is released.

Then, since the slide bar 843 moves backward by the elastic force of the spring 845, the tilting stopper 825 tilts and rotates forward to allow the extraction of the stator coils 7.

In this state, the cartridge movable guiders 829 move forward in the upward direction by the operation of the cartridge cylinder 851.

Then, the stator coil 7 positioned at the frontmost position among the stator coils 7 loaded onto the first cartridge fixed guiders 823 is lifted upward by the cartridge movable guiders 829. For example, the cartridge movable guiders 829 move forward to a higher position than the second cartridge fixed guiders 827.

Therefore, the one stator coil 7 slides along the cartridge movable guiders 829 and is stopped by the head stopper 855.

Next, the cartridge movable guiders 829 move backward in the downward direction by the operation of the cartridge cylinder 851. Therefore, one stator coil 7 slides along the second cartridge fixed guiders 827 and is mounted on the coil mounting projection 847 of the second cartridge fixed guiders 827.

Then, the clamp block 861 of the coil clampers 831 swings forward from the rear by the operation of the clamp driver 863. Accordingly, one stator coil 7 mounted on the coil mounting protrusion 847 moves forward by the clamp block 861.

Here, the leg portions 9 of the one stator coil 7 are positioned in the rail guide pockets 875 formed in the upper leg guide modules 833 and are clamped through the coil clamp grooves 865 of the clamp block 861.

For example, the leg guide blocks 885 of the lower leg guide modules 835 support the leg portions 9 at the lower side of the upper leg guide modules 833. The leg guide blocks 885 maintain the contact with the leg portions 9 by the elastic force of the spring 891.

Therefore, the leg portions 9 of the one stator coil 7 are clamped by the clamp block 861 in the rail guide pockets 875, and are supported by the leg guide blocks 885, so the set posture may be maintained.

Here, the set posture may be defined as a posture in which the interval along the up-down direction of the leg portion 9 is constant.

On the other hand, during the above-described process, the push block 915 and the cam pusher 917 of the coil insertion unit 910 move upward by the operation of the coil insertion driver 913.

Then, the array jigs 30 are transported through the conveyor 10, and one of the array jigs 30 reaches the jig docking part 70 positioned at the set docking point P1 of the conveyor 10.

When the array jig 30 reaches the jig docking part 70, the first docking base 71 of the jig docking part 70 moves upward by the operation of the docking drive source 77 and is coupled to the jig base 31 of the array jig 30.

In addition, the second docking base 73 of the jig docking part 70 moves upward by the operation of the docking drive source 77. Accordingly, the jig joint 75 of the jig docking part 70 is coupled to the rotating member 33 of the array jig 30.

Here, one stator coil 7 supported by the cartridge units 810 is positioned at the lower side of the coil insertion unit 910. The array jig 30 docked to the jig docking part 70 is positioned at the lower side of one stator coil 7.

Next, the push block 915 and the cam pusher 917 move downward by the operation of the coil insertion driver 913.

Therefore, the push block 915 presses the head portion 8 of one stator coil 7 supported by the cartridge units 810 downward.

Then, the one stator coil 7 moves downward along the rail guide pocket 875 while maintaining the set posture of the leg portions 9 by the coil clampers 831, the upper leg guide modules 833, and the lower leg guide modules 835.

As described above, the one stator coil 7 pressed by the push block 915 is inserted into the insertion space between the jig pins 37 of the array jig 30 and arrayed on the jig pins 37. Here, the jig pins 37 are radially mounted on the outer surface of the fixed rings 35 arranged in the plurality of stages along the up-down direction on the rotating member 33.

In this process, the cam pusher 917 of the coil insertion unit 910 comes into cam contact with the cam roller 883 of the lower leg guide modules 835 of the cartridge units 810 and presses the cam roller 883 downward.

Then, the cam block 881 moves backwardly while overcoming the elasticity of the spring 887, and the cam roller 883 is coupled to the cam follower groove 884 of the cartridge body 821.

Therefore, the leg guide block 885 of the lower leg guide modules 835 moves backwardly together with the cam block 881. As a result, the one stator coil 7 may be arrayed on the jig pins 37 of the array jig 30 without the interference between the head portion 8 and the leg guide block 885.

The array device 100 for a hairpin type stator coil, for example, may insert the stator coils 7 into the insertion space between the jig pins 37 by repeating the above-described series of processes and array the stator coils 7 on the jig pins 37.

Here, the jig joint 75 of the jig docking part 70 rotates by the operation of the docking drive source 77 while being coupled to the rotating member 33 of the array jig 30. Accordingly, the rotating member 33 rotates together with the fixed rings 35 by the jig joint 75.

Therefore, as the fixed rings 35 rotate in the set direction by the rotating member 33, the stator coils 7 may be arrayed in the set layer on the jig pins 37 of the fixed rings 35.

Meanwhile, in the process of arraying the stator coils 7 on the jig pins 37 of the fixed rings 35 as described above, the stator coils 7 may be arrayed on the jig springs 39 radially arranged in the set outer circumference section of the fixed rings 35 of the array jigs 30.

Here, the jig springs 39 may buffer the load of the pre-arrayed the stator coils 7 and secure the fluid space into which the stator coils 7 may be inserted.

To explain further, when other the stator coils 7 are inserted between the stator coils 7 that are already inserted between the jig pins 37, the jig pins 37 may spread apart and cause collisions with adjacent the stator coils 7.

Therefore, since the jig springs 39 are mounted in the interference section where the jig pins 37 and the stator coils 7 collide, the jig springs 39 may reduce the load applied to the stator coils 7.

On the other hand, the array device 100 for a hairpin type stator coil according to some example embodiments of the present disclosure may insert the I-shaped stator coils (not illustrated) between the jig pins 37 by the coil pockets 43 of the array jigs 30.

Here, the coil pockets 43 may cause the interference with the stator coils 7 inserted into the jig pins 37 when the fixed rings 35 rotate.

Accordingly, as the pocket moving unit 51 moves downward, it comes into cam contact with the cam member 45 of the coil pocket parts 43. Accordingly, the coil pocket parts 43 moves outside the radius of the support ring 41 by the pocket moving unit 51. As a result, the interference between the coil pocket parts 43 and the stator coils 7 may be avoided.

As described above, the array device 100 for a hairpin type stator coil, for example, may array the stator coils 7 on the array jigs 30 while maintaining the set posture of the leg portions 9 of the stator coils 7 by the cartridge units 810.

Therefore, the array device 100 for a hairpin type stator coil, for example, may absorb the dispersion of the shape of the stator coils 7 and array the stator coils 7 on the array jigs 30, thereby improving the array quality of the stator coils 7.

In addition, the array device 100 for a hairpin type stator coil, for example, may insert one stator coil 7 supported in a fixed position by the cartridge units 810 into the array jigs 30 through coil insertion units 910, so, unlike the conventional technology using the robot, the stator coils 7 may be arrayed at high speed on the array jigs 30.

Therefore, according to the array device 100 for a hairpin type stator coil according to some example embodiments of the present disclosure, the facility operation rate may be improved by arraying the stator coils 7 on the array jigs 30.

Furthermore, the array device 100 for a hairpin type stator coil, for example, applies the jig pins 37 and the jig springs 39 that have the open type of insertion spaces on the array jigs 30.

Accordingly, according to the array device 100 for a hairpin type stator coil according to some example embodiments of the present disclosure, when arraying the stator coils 7 on the array jigs 30, the structural interference of the stator coils 7 may be avoided, and the manufacturing cost of the array jigs 30 may be reduced.

Although the example embodiments of the present disclosure have been described above, the technical idea of the present disclosure is not limited to the example embodiments presented in this specification, and those skilled in the art who understand the technical idea of the present disclosure will be able to easily propose other example embodiments by adding, changing, deleting, adding, etc., components within the scope of the same technical idea, but this will also be considered to fall within the scope of the rights of the present disclosure.

<Description of symbols>

| | |
|---|---|
| 1: Stator | 3: Stator core |
| 5: Slot | 7: Stator coil |
| 8: Head portion | 9: Leg portion |
| 10: Conveyor | 30: Aarry jig |
| 31: Jig base | 33: Rotating member |
| 35: Fixed ring | 37: Jig pin |
| 39: Jig spring | 41: Support ring |
| 43: Coil pocket part | 45: Cam member |
| 51: Pocket moving unit | 70: Jig docking part |
| 71: First docking base | 73: Second docking base |
| 75: Jg joint | 77: Docking drive source |
| 100: Array device for a hairpin | |
| type stator coil | |
| 110: Frame | 111: Base frame |
| 113: Mount frame | 210: Magazine |
| 211: Magazine base | 213: Guide bar |
| 214: Support bar | 215: Door block |
| 217: Leg stopper | 219: Guide pin |
| 221: Magnet attach block | 310: Magazine stack part |
| 311: Stack frame | 313: Magazine support block |
| 315: Lift cylinder | 410: Magazine tilting part |
| 411: Tilt base | 413: Tilt cylinder |
| 510: Magazine loading unit | 511: Magazine gripper |
| 513: Multi-axis driver | 610: Magazine door opening/closing |
| 611: Main opening/closing cylinder | 612: Post |
| 613: Moving block | 615: sub-opening/closing cylinder |
| 616: Cylinder body | 617: Magnet member |
| 619: Spacer pad | 621: Mount block |
| 623: Operating rod | 710: Buffer unit |
| 711: Buffer body | 713: Magazine coil extraction part |
| 715: Buffer fixed guider | 717: Coil detection sensor |
| 719: Upper stopper | 721: Lower stopper |
| 723: Buffer movable guider | 725: First buffer cylinder |
| 727: Sensor bracket | 731: Second buffer cylinder |
| 733: Buffer movable block | 735: Connection block |
| 737: Link member | 739: Link bar |
| 741: Docking block | 810: Cartridge unit |
| 811: Moving member | 813: Cartridge driver |
| 815, 816, 921: Servo motor | 821: Cartridge body |
| 823: First cartridge fixing guider | 825: Tilting stopper |
| 827: Second cartridge fixing guider | 829: Cartridge movable guider |
| 831: Coil clamper | 833: Upper leg guide module |
| 835: Lower leg guide module | 841: Support block |
| 843: Slide bar | 845, 877, 887, 891: Spring |
| 847: Coil mounting protrusion | 851: Cartridge cylinder |
| 853: Cartridge movable block | 855: Head stopper |
| 861: Clamp block | 863: Clamp driver |
| 865: Coil clamp groove | 871: Fixed guide block |
| 872: Rotation guide block | 873: Rail groove |
| 875: Rail guide pocket | 881: Cam block |
| 883: Cam roller | 884: Cam follower groove |
| 885: Leg guide block | 910: Coil insertion unit |
| 911: Mounting bracket | 913: Coil insertion driver |
| 915: Push block | 917: Cam pusher |
| 923: Lifting block | P1: Docking point |

What is claimed is:

1. An array device for a hairpin type stator coil, configured to array hairpin type stator coils on at least one array jig transported through a conveyor, the array device comprising:
a frame;
at least one magazine that is arranged in a magazine stack part installed in the frame and has the stator coils loaded;
a magazine loading unit that is installed in the frame to load the at least one magazine into a magazine tilting part arranged in front of the magazine stack part;
at least one buffer unit that is arranged in front of the magazine tilting part to extract the stator coils one by one from the at least one magazine arranged in the magazine tilting part and load and extract the stator coils;
at least one cartridge unit that is arranged in front of the at least one buffer unit to load the stator coils extracted from the at least one buffer unit, extract the stator coils one by one, and maintain a leg portion of the extracted one stator coil in a set posture; and
a coil insertion unit that is arranged in front of the at least one cartridge unit to insert the stator coils extracted one by one from the at least one cartridge unit into the array jig.

2. The array device of claim 1, further comprising:
at least one magazine door opening/closing part that is installed on a post mounted on the frame to open/close a door block mounted on an upper portion of the at least one magazine.

3. The array device of claim 2, wherein the at least one magazine door opening/closing part comprises:
a moving block that is connected to a main opening/closing cylinder installed on the post and moves forward and backward in an up-down direction by an operation of the main opening/closing cylinder;
a sub-opening/closing cylinder that is installed on the moving block and has a magnet member mounted on an end portion of an operating rod that is movable forward and backward in the up-down direction; and
a spacer pad made of a rubber material that is fixed to a cylinder body of the sub-opening/closing cylinder so that the operating rod penetrates therethrough, and
the magnet member is coupled to a magnet attach block fixed to the door block.

4. The array device of claim 1, wherein the at least one buffer unit comprises:
a buffer body that is fixed to the frame;
a magazine coil extraction part that is connected to a first buffer cylinder installed in the buffer body and arranged along an inclination direction of the at least one magazine tilted by the magazine tilting part;
a pair of buffer fixed guiders that is fixed to an upper portion of the buffer body with the magazine coil extraction part interposed therebetween and arranged along the inclination direction; and
a buffer movable guider that is arranged between the buffer fixed guiders, connected to a second buffer cylinder installed in the buffer body, and arranged along the inclination direction.

5. The array device of claim 4, wherein the at least one buffer unit further comprises:
at least one coil detection sensor that is installed in the buffer body to detect the quantity of the stator coils loaded onto the buffer fixed guiders;
an upper stopper that is mounted on the upper portion of the buffer body to support a head portion of the stator coils loaded onto the buffer fixed guiders; and
a lower stopper that is installed on a lower portion of the buffer body to be movable in the up-down direction to support leg portions of the stator coils,
wherein the buffer movable guider moves to a position higher than the upper stopper by the second buffer cylinder.

6. The array device of claim 5, wherein:
the buffer movable guide is coupled to a buffer movable block connected to the second buffer cylinder,
a connection block is coupled to the buffer movable block along the up-down direction, and
the lower stopper and the connection block are link-coupled to a seesaw type link member installed on the buffer body.

7. The array device of claim 1, wherein the at least one cartridge unit comprises:
a cartridge body that is connected to a cartridge driver installed on the frame and mounted on a movable member installed on the frame so as to be movable in the front-back and left-right directions;
a pair of first cartridge fixing guiders that is fixed obliquely in a front-back direction on the upper portion of the cartridge body;
a pair of second cartridge fixing guiders that are connected to front portions of the first cartridge fixing guiders and are fixed obliquely to the cartridge body along an inclination direction of the first cartridge fixing guiders; and
a pair of cartridge movable guiders that are connected to a cartridge cylinder installed in the cartridge body and are arranged obliquely along the inclination direction.

8. The array device of claim 7, wherein:
the second cartridge fixing guiders are arranged higher than the first cartridge fixing guiders, and each of the second cartridge fixing guiders is provided with a coil mounting protrusion; and
the cartridge movable guiders are fixed to a cartridge movable block connected to the cartridge cylinder, with a head stopper supporting a head portion of the one stator coil mounted on the cartridge movable block.

9. The array device of claim 8, wherein the at least one cartridge unit comprises:
a pair of coil clampers that is rotatably installed in the cartridge body;
a pair of upper leg guide modules that is installed in the cartridge body in front of the coil clampers; and
a pair of lower leg guide modules that is arranged between the upper leg guide modules and movably mounted in the cartridge body in the front-back direction.

10. The array device of claim 9, wherein each of the coil clampers comprises:
a clamp block that is connected to a clamp driver installed in the cartridge body and has coil clamp grooves formed at positions corresponding to the upper leg guide modules, and
each of the upper leg guide modules comprises:
a fixed guide block that is fixed to the cartridge body along the up-down direction and provided with a rail groove supporting the leg portion of the one stator coil; and
a rotation guide block that is rotatably mounted on the fixed guide block so as to be joined with the rail groove and form a rail guide pocket and connected to the fixed guide block through a spring.

11. The array device of claim 9, wherein each of the lower leg guide modules comprises:
a cam roller that is rotatably installed on a cam block movably mounted in the front-back direction through a spring on the cartridge body and selectively coupled to a cam follower groove formed on the cartridge body; and
a leg guide block that is connected to a front portion of the cam block through the spring so as to come into contact with the leg portion of the one stator coil and is rotatably mounted on the cam block.

12. The array device of claim 7, wherein the at least one cartridge unit further comprises:
a tilting stopper that is rotatably mounted on the cartridge body to support the stator coils loaded onto the first cartridge fixing guiders,
a support block is mounted on the cartridge body,
a slide bar is mounted on the support block so as to be movable in the front-back direction through the spring, and
the tilting stopper is rotatably coupled to the support block and is jointly coupled to a front end portion of the slide bar.

13. The array device of claim 1, wherein the coil insertion unit comprises:
a coil insertion driver that is installed on a mounting bracket fixed to the frame;
a push block that is connected to the coil insertion driver and movably provided in the up-down direction by the operation of the coil insertion driver; and
a cam pusher that is coupled to the push block.

14. The array device of claim 1, further comprising:
a jig docking part that is docked and coupled to the at least one array jig and installed at a docking point set on the conveyor so as to rotate the at least one array jig.

15. The array device of claim 14, wherein the at least one array jig comprises:
a rotating member that is docked and coupled to the jig docking part and rotatably mounted on a jig base;
at least one fixed ring that is coupled to the rotating member;
a plurality of jig pins that are radially arranged on at least one fixed ring; and
at least one jig spring that is radially arranged on a set outer circumference of the at least one fixed ring.

16. The array device of claim 15, wherein the at least one array jig further comprises:
a support ring that is fixed to the jig base with the at least one fixed ring arranged on the inside; and
a plurality of coil pockets that are radially movably mounted on the support ring and move radially outwardly of the support ring by a pocket moving unit installed on the conveyor.

17. An array device comprising:
a frame;
at least one magazine arranged to hold a plurality of hairpin-type stator coils;
a buffer unit positioned to receive and extract the stator coils from the at least one magazine, each extracted coil being maintained in a set posture;
at least one cartridge unit arranged to receive the extracted coils from the buffer unit; and
a coil insertion unit configured to insert the stator coils from the cartridge unit into at least one array jig,
wherein the magazine, buffer unit, cartridge unit, and coil insertion unit are arranged along a process path so that the hairpin-type stator coils are automatically transferred, oriented, and inserted into the at least one array jig.

18. The array device of claim 1, wherein the buffer unit comprises:
a buffer body fixed to the frame;
at least one buffer cylinder coupled to a magazine coil extraction part that is arranged along an inclined direction to withdraw coils from the tilted amgaine;
a pair of buffer fixed guiders disposed along the inclined direction;
a buffer movable guider disposed between the buffer fixed guiders and operably connected to a second buffer cylinder for movement along the inclined direction;
a lower stopper arranged at a lower portion of the buffer body and movable in an up-down direction so as to support a leg portion of each extracted coil; and
a seesaw-type link member coupling the lower stopper to a connection block that travels with the buffer movable guider, so that upward or downward motion of the buffer movable guider is linked to motion of the lower stopper.

19. The array device of claim 1, wherein the at least one cartridge unit comprises:
a cartridge body mounted on a movable member so as to be displaceable in a front-back and left-right direction;
a pair of first cartridge fixing guiders that is disposed obliquely in a front-back direction on an upper portion of the cartridge body;
a pair of first cartridge fixing guiders that is disposed obliquely in a front-back direction on an upper portion of the cartridge body;
a pair of second cartridge fixing guiders connected respectively to front portions of the first cartridge fixing guiders and arranged obliquely along an inclination direction of the first cartridge fixing guiders; and
at least one coil clamper configured to temporarily clamp each stator coil received from the buffer unit and hold the coil in alignment for insertion into the array jig.

20. The array device of claim 1 wherein the coil insertion unit comprises:
a coil insertion driver mounted on a bracket fixed to the frame;
a push block connected to the coil insertion driver and movable up and down by operation of the coil insertion driver; and
a cam pusher coupled to the push block and arranged to push each stator coil into the at least one array jig.
